(19) United States
(12) Patent Application Publication
(10) Pub. No.: US 2024/0331110 A1
(43) Pub. Date: Oct. 3, 2024

(54) LOCAL IMAGE CORRECTION

(71) Applicant: SparkCognition, Inc., Austin, TX (US)

(72) Inventors: Elad Liebman, Austin, TX (US); Alexandru Ardel, Austin, TX (US); Ram Tuvi, Austin, TX (US); Yash Gandhi, Austin, TX (US); Dimitri Voytan, Austin, TX (US)

(21) Appl. No.: 18/618,317

(22) Filed: Mar. 27, 2024

Related U.S. Application Data
(60) Provisional application No. 63/492,392, filed on Mar. 27, 2023.

(51) Int. Cl. G06T 5/70; G01V 1/34; G06T 5/20

(52) U.S. Cl. CPC G06T 5/70; G01V 1/345; G06T 5/20

(57) ABSTRACT

A method includes obtaining waveform return data including waveform return records for multiple sampling events associated with an observed area and generating image data based on the first subset of waveform return records. The method also includes reducing imaging artifacts in a region of interest of the image data using beam-domain local correction operations.

### CROSS-REFERENCE TO RELATED APPLICATIONS

The present application claims priority from U.S. Provisional Patent Application No. 63,492,392, entitled “LOCAL IMAGE CORRECTION”, filed Mar. 27, 2023, the contents of which are incorporated herein by reference in their entirety.

### FIELD

The present disclosure is generally related to local correction of images based on sparse waveform return data.

### BACKGROUND

Conceptually, a “forward problem” attempts to make a prediction based on a model of causal factors associated with a system and initial conditions of the system. An “inverse problem” reverses the forward problem by attempting to model causal factors and initial conditions based on data (e.g., measurements or other observations of the system). Stated another way, an inverse problem starts with the effects (e.g., measurement or other data) and attempts to determine model parameters, whereas the forward problem starts with the causes (e.g., a model of the system) and attempts to determine the effects. Inverse problems are used for many remote sensing applications, such as radar, sonar, medical imaging, computer vision, seismic imaging, etc.

Optimization techniques are commonly used to generate solutions to inverse problems. For example, with particular assumptions about a system that generated a set of return data, a reverse time migration technique can be used to generate image data representing the system. However, images generated using such techniques generally include artifacts. Such artifacts can be reduced by increasing the quantity of data used to generate the solution; however, generating more data is costly and time consuming. Furthermore, the computing resources required to perform optimization increase dramatically as the amount of data increases.

### BRIEF DESCRIPTION OF THE DRAWINGS

FIG. 1 is a diagram illustrating particular aspects of a system to generate image data using a selected subset of available waveform return data in accordance with some aspects of the present disclosure.

FIG. 2 is a diagram illustrating particular aspects of portions of the system of FIG. 1 in accordance with some aspects of the present disclosure.

FIG. 3 illustrates a flow chart of an example of a method of generating image data using a selected subset of available waveform return data in accordance with some aspects of the present disclosure.

FIG. 4 illustrates an example of a computer system configured to use machine-learning to generate image data using a selected subset of available waveform return data in accordance with some aspects of the present disclosure.

FIG. 5 is a flow chart of an example of a method of generating image data that includes reducing artifacts in solution data associated with an inverse problem.

FIG. 6 is a flow chart of an example of a method of training a machine-learning model of a gradient descent artifact reduction system.

FIG. 7 is a diagram illustrating particular aspects of determining parameters of a gradient descent artifact reduction system.

FIG. 8A is a diagram illustrating a solution generated via reverse time migration based on a large set of waveform return data.

FIG. 8B is a diagram illustrating a solution generated via reverse time migration based on a much smaller set of waveform return data than used for FIG. 8A.

FIG. 8C is a diagram illustrating a solution generated, based on the same size set of waveform return data as used for FIG. 8B, via reverse time migration and gradient descent artifact reduction, according to particular aspects disclosed herein.

FIG. 9A is a diagram illustrating a solution generated via reverse time migration based on a large set of waveform return data.

FIG. 9B is a diagram illustrating a solution generated via reverse time migration based on a much smaller set of waveform return data than used for FIG. 9A.

FIG. 9C is a diagram illustrating a solution generated, based on the same size set of waveform return data as used for FIG. 9B, via reverse time migration and gradient descent artifact reduction, according to particular aspects disclosed herein.

FIG. 10 is a diagram illustrating aspects of beam domain image processing in accordance with some aspects of the present disclosure.

FIG. 11 is a diagram illustrating aspects of beam domain image processing in accordance with some aspects of the present disclosure.

FIG. 12 is a diagram illustrating aspects of beam domain image processing in accordance with some aspects of the present disclosure.

FIG. 13 is an image generated via reverse time migration based on a large set of waveform return data.

FIG. 14 is an image generated using a small subset of the waveform return data used to generate FIG. 13 and using image processing techniques described with reference to FIG. 1-9C.

FIG. 15 is an image generated using the waveform return data and techniques used to generate FIG. 14 and local correction of a region of interest according to the local image correction techniques disclosed herein.

### DETAILED DESCRIPTION

Subsurface images obtained by a sparse set of shots are marred with imaging artifacts. Aspects disclosed herein enable fast local correction of such noisy seismic images. More specifically, the techniques disclosed herein enable increasing the resolution of images obtained by a sparse set of shots. Systems and methods disclosed herein use beam-based migration to reduce the migration imaging artifacts without increasing the number of shots. The beam-based migration approach allows a fast, efficient, and accurate way to reduce the image artifacts producing results comparable to a full stack image.

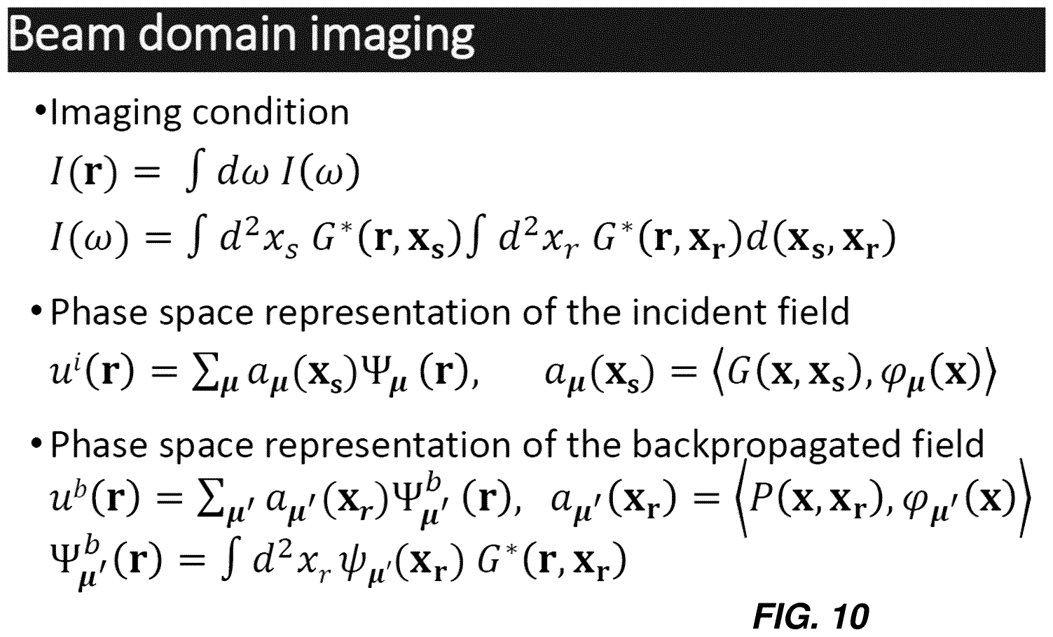

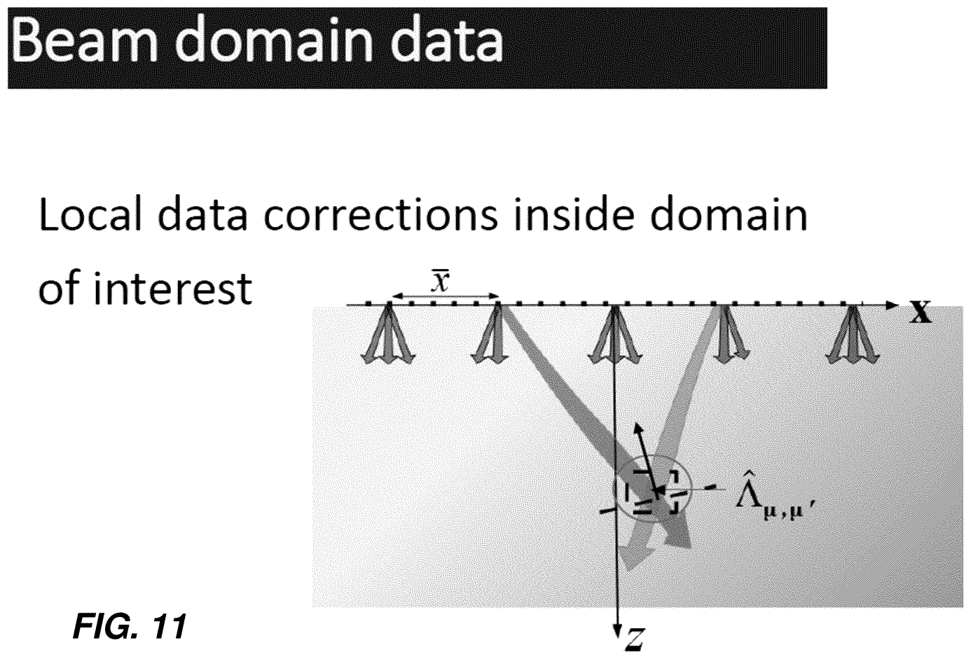

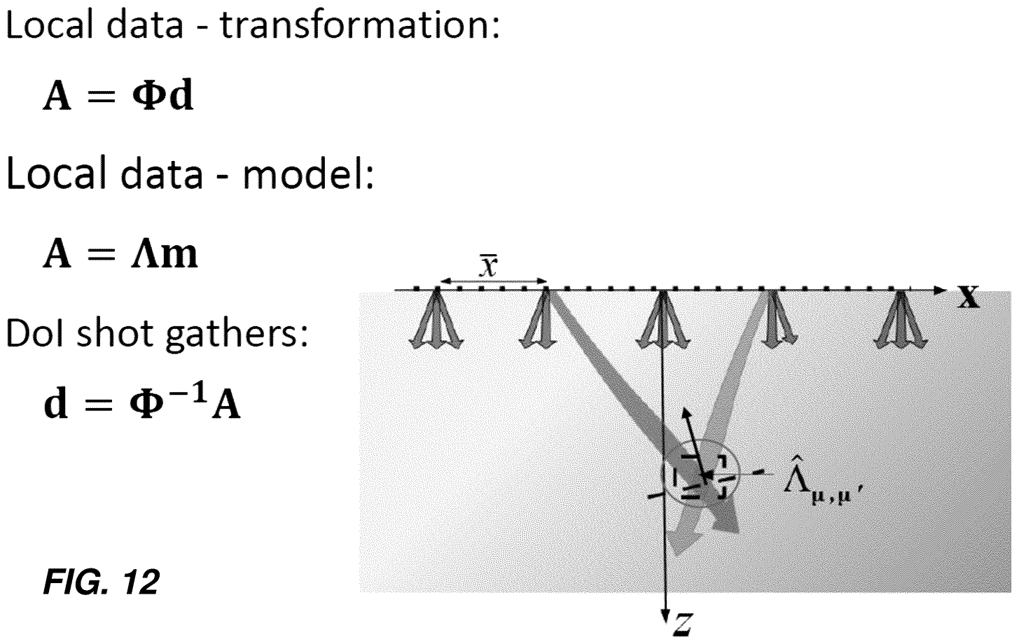

In the local correction method disclosed herein, local reduction of imaging artifacts is performed based on transforming the imaging problem from the shot-data domain to the beam domain. The formulation is based on windowed Fourier transform frames expansion of the surface field and scattering data, as a superposition of beam. Performing the local correction method includes using beams to determine local basis functions to represent the scattering data in the beam domain. The beam domain data has a cogent physical interpretation. The transformed beam-to-beam scattering data captures local Snell's law reflection of the scattering targets. This observation can be obtained directly from the data and does not require wave propagation calculations. The corresponding beam data is sparse, where only beams with high amplitude are needed for imaging, and thus a-priori compresses the size of the migration problem. For a region of interest within the image (e.g., a low-resolution region of interest in the noisy image), the spectral locality property of the beams is used to facilitate artifact reduction. For example, beams that pass near this region of interest are identified and processed as described with reference to FIGS. 10-12. This two-phase image construction process (e.g., generating an image using sparse shot data then reducing artifacts in a region of interest) leads to a-priori target-oriented sparse imaging conditions. The improved local image portion (e.g., the region of interest after artifact reduction) replaces the corresponding noisy image portion in the region of interest to generate an image with fewer imaging artifacts, especially in the region of interest, without increasing the number of shots processed.

In some embodiments, the disclosed local correction methods can be combined with careful selection of the region of interest to significantly improve the utility of a set of shot data. For example, it is often the case that particular subsurface features are of greater interest than others. To illustrate, salt bodies can trap hydrocarbons, so details of areas around and/or under salt bodies are often of significant interest. The disclosed local correction methods can be used to reduce artifacts in portions of an image representing a salt body to enable better decision making regarding such regions without the need to process the entire imaged areas using complex and expensive artifact reduction techniques.

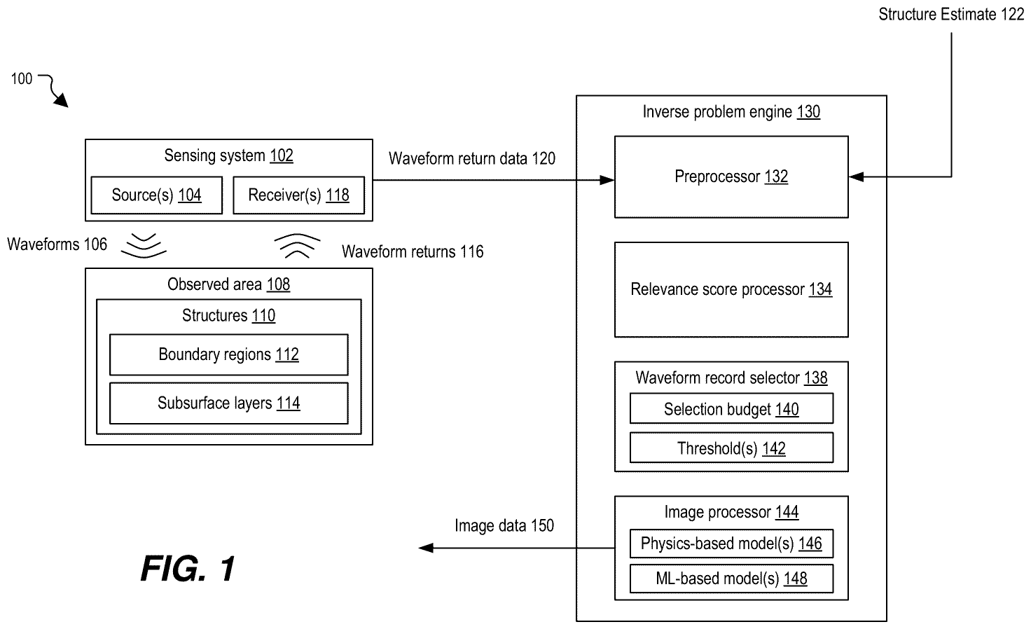

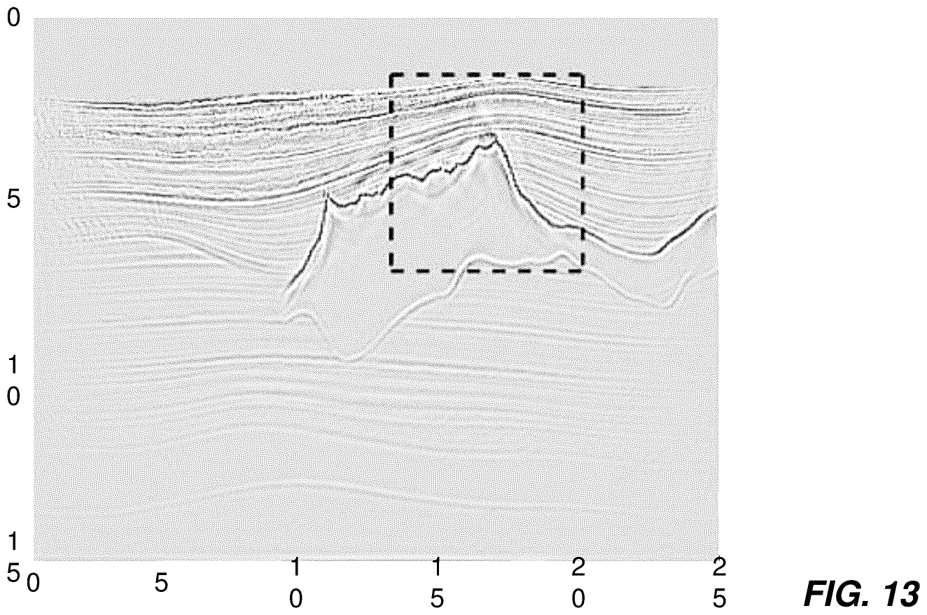

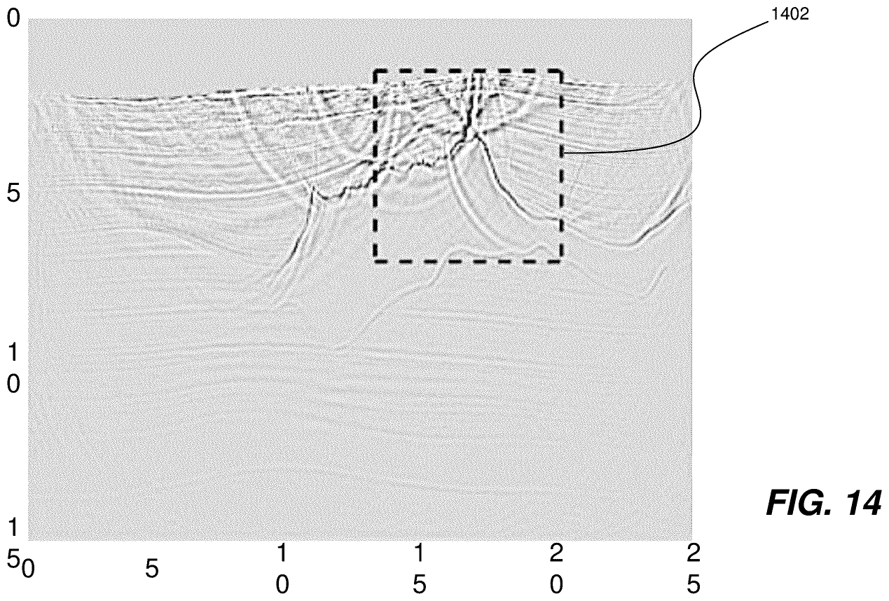

Results of the local correction method described above were demonstrated using the Seam data set and are shown in FIGS. 13-15. For comparison, a reference full stack image based on migration swing of 243 sources is shown in FIG. 13. A noisy image generated using the image processing techniques described with reference to FIGS. 1-9C using only 8 shots is shown in FIG. 14. Although the techniques described with reference to FIGS. 1-9C were used to generate the noisy image, other denoising filtering operations could be used instead of, or in addition to, such techniques. The noisy image of FIG. 14 contains a large deviation inside the black rectangle 1402.

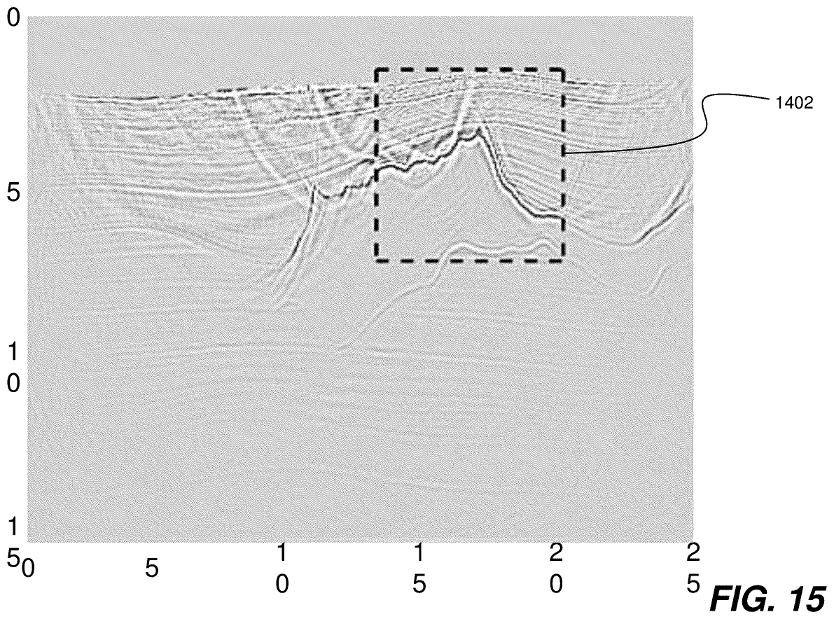

The local correction method disclosed herein was used to increase the resolution of the sparse shots image in a region of interest corresponding to the black rectangle 1402. A resulting locally corrected image is illustrated in FIG. 15.

To generate the locally corrected image of FIG. 15, beam transformation was used to compress the scattering data. In this particular example, the beam transformation enables identifying the significant scattering data (i.e., the scattering data relevant to the region of interest) with only ten percent of the scattering beam data. Only beams that pass inside the region of interest are used to construct the locally corrected portion of the image. A matching filter is used to identify and replace a portion of the noisy image corresponding to the region of interest with the image obtained with the local correction method. As shown in FIG. 15, the locally corrected image has reduced the image artifacts and noise and matches the reflectors in the reference full stack image.

Thus, the disclosed techniques provide target-oriented and fast image correction using a sparse data set by transforming from a shot gathers domain into a beam domain for image processing. A technical benefit of this transformation is that only relevant pairs of beams (i.e., beams that pass through the region of interest) are used to construct the image. Unlike other beam-based migration methods, this provides a-priori compression, resulting in faster image processing, higher quality images, and more efficient use of computing resources.

In some aspects, the local correction methods described above and with reference to FIGS. 10-15 begin from a sparse image that can be generated using techniques described below with reference to FIGS. 1-9C. In other implementations, other image processing techniques can be used to generate a noisy image using a sparse data set.

The waveform return data includes data based on records (referred to herein as “waveform return records”) for multiple sampling events associated with an observed area. The image data represents a solution to an inverse problem associated with the waveform return data. For example, the waveform return data may be generated by a seismic imaging system that includes one or more sources and one or more receivers. In this example, during a particular sampling event, the source(s) cause one or more waveforms to propagate in the observed area. Subsurface features within the observed area reflect the waveform(s), and the receiver(s) generate measurements (“waveform return measurements”) that indicate, for example, a magnitude of a received waveform return, a timing of receipt of the waveform return, etc. In this example, a waveform return record of the particular sampling event may include the waveform return measurements generated by the receiver(s) for the particular sampling event. Further, in this example, the waveform return data for the particular sampling event may be identical to the waveform return record, or the waveform return data may represent the waveform return record after particular data transformation operations are performed. To illustrate, the waveform return records generally include time-series data, and the waveform return data may include time-series data or may include depth domain data or images based on the time-series data.

In imaging applications, traditional methods to generate solutions to inverse problems, such as reverse time migration, use large datasets (e.g., waveform return data) in order to, among other things, reduce migration swing artifacts (which are referred to herein as “artifacts”) in the resulting image. The computing resources used to generate an image via reverse time migration increase as the size of the dataset processed increases. However, the artifact level (e.g., the number and/or severity of artifacts) in the image generally decreases as the size of the dataset processed increases. Thus, a large dataset may be processed if a high-quality image is to be generated but processing such a large dataset is very resource intensive in terms of processor cycles, memory read/write cycles, and memory footprint.

Optimization techniques may be employed to reduce the computing resources used to generate an image with acceptable quality (e.g., with few enough artifacts and/or with artifacts of particular types or severity). Such optimization techniques may include artifact reduction techniques to generate an image with acceptable quality using a smaller dataset. However, in many applications, each waveform return record represents a wave that illuminates only a small portion of an observed area. Further, some waveform return records in a large dataset may be duplicative or nearly so. Thus, for a particular dataset, the final image quality can be different depending on which particular subset of data from the dataset are processed.

Techniques disclosed herein facilitate careful selection of a subset of the available waveform return data to enable computationally efficient generation of an image with acceptable quality. For example, the disclosed techniques determine relevance scores for waveform return records of the available waveform return data and select a subset of the waveform return data, based on the relevance scores, for processing. The relevance scores are determined based on estimated information gain associated with the waveform return records. In some implementations, the information gain associated with a particular waveform return record is estimated based on one or more of a variety of relevant metrics, such as a mutual information metric, a cross correlation distance metric, or a mean square error reduction metric. In some implementations, the information gain associated with a particular waveform return record is estimated based on output of a machine-learning model. In general, “information gain” as used herein refers to any metric that provides an indication of how much information about the observed area can be gained by adding particular waveform return record(s) to the set of waveform return data processed to generate the image of the observed area.

In some implementations, an information gain metric associated with a particular waveform return record provides a quantitative or qualitative estimate of information content of the particular waveform return record relative to one or more reference waveform return records. The reference waveform return record(s) may include, for example, a set of waveform return records that have already been selected for processing to generate image data. In this example, a waveform return record that is being considered for processing to generate image data is compared to the waveform return record(s) that have already been selected for processing to estimate how much new information would be gained by processing the waveform return record under consideration.

In some implementations, an information gain metric associated with a particular waveform return record provides a quantitative or qualitative estimate of information content of the particular waveform return record relative to an estimate of structure (referred to herein as a “structure estimate”) of the observed area. For example, in the context of seismic imaging, the structure estimate may include a velocity model associated with the observed area. In such implementations, a waveform return record that is being considered for processing to generate image data is compared to the structure estimate to determine how much information would be gained by processing the waveform return record under consideration.

In some implementations, the relevance score associated with a particular waveform return record is based on information gain of the particular waveform return record relative to one or more reference waveform return records and based on information gain of the particular waveform return record relative to a structure estimate. For example, when mutual information in used as a metric to quantify information gain, a high relevance score may be assigned to a waveform return record that has low mutual information with respect to the reverence waveform return record(s) and has high mutual information with respect to the structure estimate. In this example, high mutual information with respect to the structure estimate indicates that the waveform return record under consideration is highly relevant to the structure estimate (e.g., illuminates subsurface structures of interest), and low mutual information with respect to the reference waveform return record(s) indicates that the waveform return record under consideration includes information that is not duplicative of information that is adequately represented by the reference waveform return record(s).

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. Further the terms “comprise,” “comprises,” and “comprising” may be used interchangeably with “include,” “includes,” or “including.” Additionally, the term “wherein” may be used interchangeably with “where.” As used herein, “exemplary” may indicate an example, an implementation, and/or an aspect, and should not be construed as limiting or as indicating a preference or a preferred implementation.

As used herein, an ordinal term (e.g., “first,” “second,” “third,” “Nth,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements. Additionally, in some instances, an ordinal term herein may use a letter (e.g., “Nth”) to indicate an arbitrary or open-ended number of distinct elements (e.g., zero or more elements). Different letters (e.g., “N” and “M”) are used for ordinal terms that describe two or more different elements when no particular relationship among the number of each of the two or more different elements is specified. For example, unless defined otherwise in the text, N may be equal to M, N may be greater than M, or N may be less than M.

In the present disclosure, terms such as “determining,” “calculating,” “estimating,” “shifting,” “adjusting,” etc. may be used to describe how one or more operations are performed. Such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general-purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time-series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

FIG. 1 is a diagram illustrating particular aspects of a system 100 to generate image data 150 using a selected subset of available waveform return data in accordance with some aspects of the present disclosure. In FIG. 1, the system 100 includes a sensing system 102 and an inverse problem engine 130. The sensing system 102 is configured to generate waveform return data 120 for an observed area 108, and the inverse problem engine 130 is configured to use a subset of the waveform return data 120 to generate the image data 150.

The sensing system 102 includes one or more sources 104 and one or more receivers 118. The source(s) 104 are configured to emit waveforms 106 into the observed area 108. Structures 110 in the observed area 108, such as boundary regions 112 around subsurface layers 114 of the observed area 108 cause the waveform 106 to be reflected back toward a surface of the observed area 108. The receivers 118 are configured to detect waveform returns 116 resulting from the reflection of the waveforms 106 and to generate the waveform return data 120 based on the waveform returns 116. Portions of the waveforms 106 may be refracted by a first of the subsurface layers 114 (e.g., a layer at a first depth) and reflected from a second of the subsurface layers 114 (e.g., a layer at a second depth that is below the first depth).

In some implementations, the waveform return data 120 include or correspond to time-series data, such as data indicating a delay between emission of a waveform 106 by a particular source 104 and receipt of a waveform return 116 by a particular receiver 118. In some implementations, time-series data of the waveform return data 120 also indicates an amplitude of the waveform 106, an amplitude of the waveform return 116, or both. When the sensing system 102 includes multiple receivers 118, the time-series data of the waveform return data 120 may include a time series associated with each receiver 118 or a stacked time series representing multiple receivers 118. Additionally, the waveform return data 120 may include or be accompanied by acquisition geometry data that indicates the positions of source(s) 104 and receiver(s) 118 when each waveform return 116 was received.

Emission of one or more waveforms 106 by the source(s) 104 and receipt of corresponding waveform returns 116 by the receiver(s) 118 represents a single sampling event. The waveform return data 120 may include at least one waveform return record (e.g., time-series data representing the waveform returns 116) for each sampling event. In some implementations, the waveform return data 120 include waveform return records for multiple sampling events. For example, in some implementations, the sensing system 102 may initiate multiple sensing events at a particular acquisition geometry in accordance with a test sequence. In the same or different implementations, the sensing system 102 may initiate sensing events at multiple different acquisition geometries in accordance with the test sequence.

The time between emission of a particular waveform 106 and reception of a corresponding waveform return 116 at a particular receiver 118 is generally related to the depth of the subsurface layer 114 that reflected the waveform 106 and propagation velocity of the waveforms 106 in the various subsurface layers 114. A structure estimate 122 may be generated based on historical data (e.g., previously collected waveform return data), a subset of the waveform return data 120, and/or additional information (such as test boreholes). In some implementations, the sensing system 102 includes a computing device to transform time-domain data based on the waveform returns 116 to depth-domain data such that the waveform return data 120 include depth data rather than or in addition to the time-series data. In other implementations, a component of the inverse problem engine 130, such as a preprocessor 132, may determine the depth-domain data based on time-series data and acquisition geometry data of the waveform return data 120.

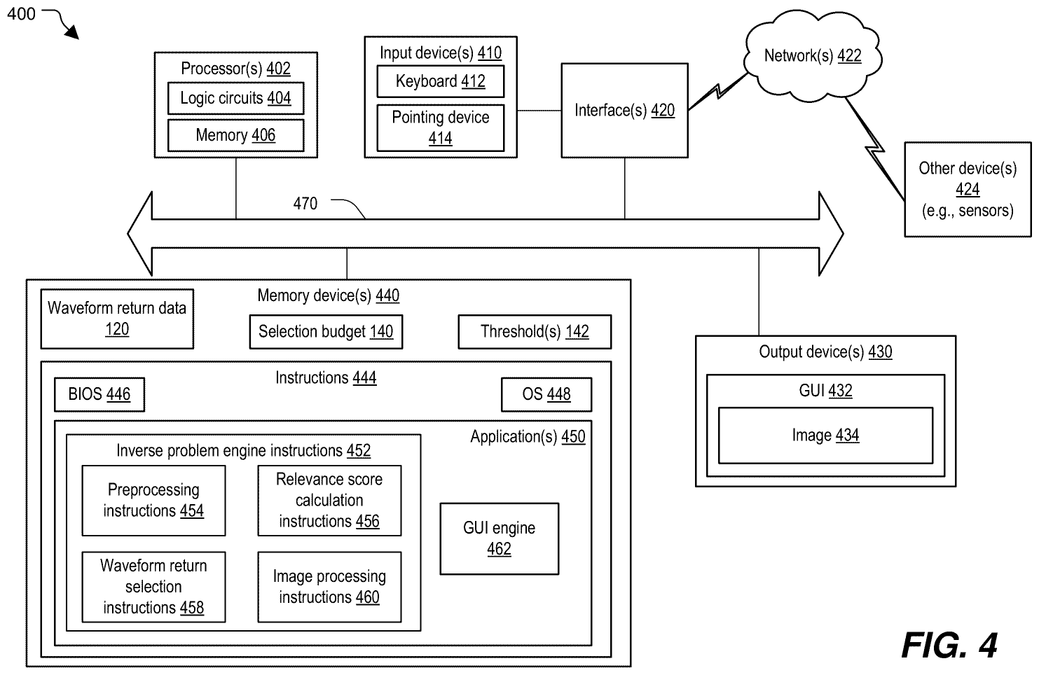

In the example illustrated in FIG. 1, the waveform return data 120 and the structure estimate 122 are provided to the inverse problem engine 130. FIG. 1 illustrates the sensing system 102 sending the waveform return data 120 to the inverse problem engine 130; however, in many implementations, the sensing system 102 generates the waveform return data 120 and stores data representing the waveform return data 120 at one or more data storage devices (such as at one of the other devices 424 of FIG. 4), and one or more computing devices executing instructions corresponding to the inverse problem engine 130 obtain the waveform return data 120 and/or the structure estimate 122 (perhaps indirectly) from the data storage device(s).

As one particular example, the sensing system 102 may include a seismic data acquisition system. In this particular example, the source(s) 104 correspond to seismic pulse generation device(s) (such as an explosive device, an airgun, or a vibrator truck), and the receiver(s) 118 correspond to specialized microphone(s) (such as a geophone or a hydrophone). In this particular example, each sampling event may be referred to as a “shot,” and each waveform return record of the waveform return data 120 may be referred to as a “shot record” or a “shot trace.” In other examples, the sensing system 102 includes another type of data acquisition system, such as a sonar system, a radar system, a lidar system, an ultrasound imaging system, etc.

In the example illustrated in FIG. 1, the inverse problem engine 130 includes the preprocessor 132, a relevance score processor 134, a waveform record selector 138, and an image processor 144. The preprocessor 132 is configured to perform preprocessing operations to prepare the waveform return data 120, the structure estimate 122, or both, for processing by other components of the inverse problem engine 130. For example, the preprocessor 132 may normalize, filter, or augment the waveform return data 120. As another example, the preprocessor 132 may perform a domain transform, such as to convert time-domain data of the waveform return data 120 to depth-domain data. In some implementations, the preprocessor 132 may use each waveform return record of the waveform return data 120 to generate image data representing reflection coefficients of the boundary regions 112 by depth in the observed area 108. For example, the preprocessor 132 may perform reverse time migration or ray tracing for each waveform return record of the waveform return data 120. In some implementations, the preprocessor 132 segments the structure estimate 122 (e.g., using an image segmentation algorithm, such as the graph-based image segmentation method described by Felzenszwalb and Huttenlocher) to identify approximate locations of the boundary regions 112 between the subsurface layers 114 of the observed area 108. In other implementations, the structure estimate 122 includes information indicating approximate locations of the boundary regions 112 between the subsurface layers 114 of the observed area 108. In some implementations, the preprocessor 132 generates boundary data that designates a region on either side of the identified boundary as a region of interest.

The relevance score processor 134 is configured to determine a relevance score for each waveform return record of the waveform return data 120. The relevance score of a particular waveform return record is indicative of the utility of the particular waveform return record for constructing desired image data (e.g., the image data 150). In a particular implementation, the relevance score for the particular waveform return record is based on a prediction of information gain associated with the particular waveform return record. For example, the relevance score of a particular waveform return record may be based on a measure of mutual information between the particular waveform return record and the structure estimate 122. As another example, the relevance score of a particular waveform return record may be based on a measure of mutual information between the particular waveform return record and one or more other waveform return records. In still other examples, information gain associated with a particular waveform return record may be predicted based on a different metric than mutual information, such as a cross correlation distance, a mean square error reduction, etc.

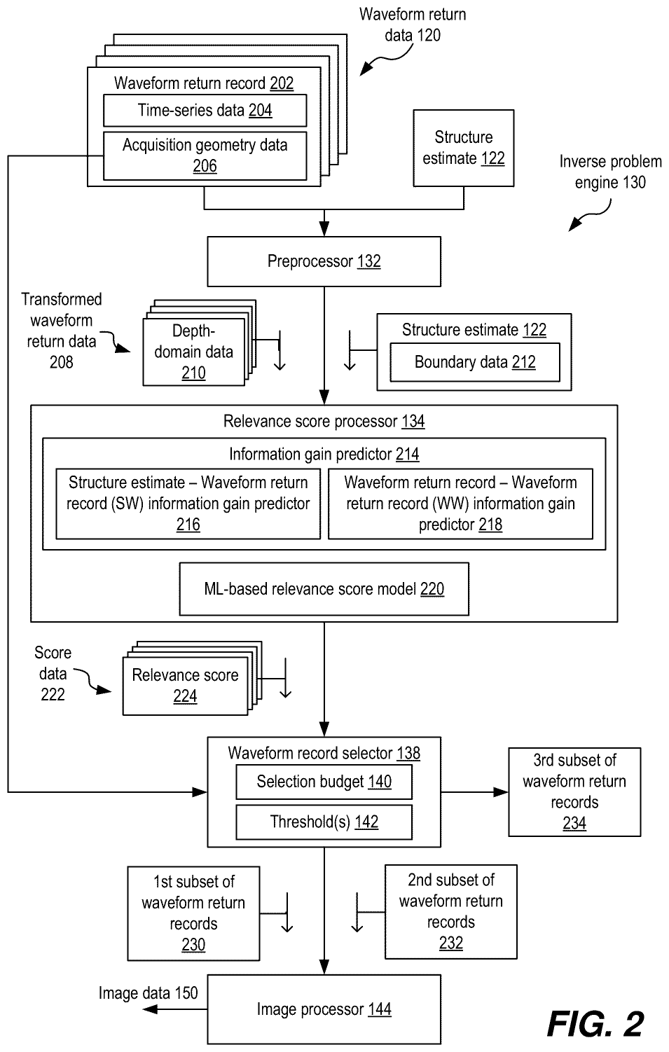

In some implementations, the value indicative of predicted information gain is expressly calculated. For example, the relevance score processor 134 may include an information gain predictor (e.g., information gain predictor 214 of FIG. 2) configured to calculate the mutual information between two sets of data, such as image data representing a particular waveform return record and image data representing the structure estimate 122, or image data representing a first waveform return record and image data representing a second waveform return record.

In some implementations, the relevance score processor 134 includes a machine-learning (ML)-based relevance score model (e.g., ML-based relevance score model 220 of FIG. 2) that is trained to determine a relevance score based on input data. For example, the relevance score processor 134 may provide input data representing a particular waveform return record and the structure estimate 122 as input to the ML-based relevance score model, and the ML-based relevance score model may generate as output a relevance score of the particular waveform return record.

In some implementations, the relevance score processor 134 includes both an information gain predictor and a ML-based relevance score model. For example, the information gain predictor may be configured to calculate a first value that is indicative of predicted information gain of a particular waveform return record relative to the structure estimate 122 and to calculate a second value that is indicative of predicted information gain of a particular waveform return record relative to one or more other waveform return records. In this example, the ML-based relevance score model may be configured to generate a relevance score value of the particular waveform return record based on the first and second values.

In some implementations, the relevance score processor 134 determines the relevance scores based on depth-domain data of the waveform return records. For example, the sensing system 102 may generate depth-domain data representing the waveform returns 116 or the preprocessor 132 may generate depth-domain data representing the waveform return data 120 (e.g., using reverse time migration or ray tracing). In some such implementations, the depth-domain data may include an image representing each waveform return record, and a value of the relevance score of the particular waveform return record may be determined based on a pixel-by-pixel comparison of the image that is based on the particular waveform return record and an image representing the structure estimate 122 or an image based on one or more other waveform return records. In other implementations, the relevance score processor 134 determines the relevance scores based on time-domain data of the waveform return records.

The waveform record selector 138 is configured to select a subset of the available waveform return data 120 to be used to generate the image data 150. In this context, the subset is a proper subset. Put another way, the waveform return data 120 include the subset used to generate the image data 150 and include one or more additional waveform return records that are omitted from the subset used to generate the image data 150.

In a particular implementation, the waveform record selector 138 is configured to select at least some of the waveform return data 120 for inclusion in the subset based on the relevance scores. For example, the waveform record selector 138 may select a first subset of waveform return records for inclusion in the subset of waveform return data used to generate the image data 150 based on the relevance scores.

Additionally, in some implementations, the waveform record selector 138 may be configured to select other waveform return records for inclusion in the subset used to generate the image data 150 based on other factors (e.g., irrespective of the relevance scores). For example, the waveform record selector 138 may select a second subset of waveform return records for inclusion in the subset used to generate the image data 150, where the second subset of waveform return records is selected, based on acquisition geometries, to be distributed about the observed area 108.

In some implementations, the number of waveform return records selected for inclusion in the subset used to generate the image data 150 is specified by a selection budget 140. In some implementations, the waveform record selector 138 is configured to select two or more distinct (e.g., mutually exclusive) groups of waveform return records to be used to generate the image data 150. For example, the selection budget 140 may specify a first count of waveform return records to be included in a first subset (e.g., waveform return records selected based on the relevance scores) and a second count of waveform return records to be included in a second subset (e.g., waveform return records selected independently of the relevance scores). As another example, the selection budget 140 may specify a count of waveform return records to be included in one of the groups of waveform return records (e.g., the first subset or the second subset described above) and a total count of waveform return records to be used to generate the image data 150.

In some implementations, the selection budget 140 specifies a total count of waveform return records to be used to generate the image data 150, and one or more thresholds 142 are used to determine the distribution of waveform return records between two or more selected groups (e.g., the first subset and the second subset described above). For example, one of the threshold(s) 142 may indicate a threshold relevance score for a waveform return record to be included in the first subset (e.g., the subset that is based on the relevance scores). In this example, each waveform return record associated with a relevance score greater than the threshold may be included in the first subset and used to generate the image data 150. In this example, if the waveform return records selected based on the relevance score satisfy the selection budget 140, no additional waveform return records are added to the subset of waveform return records used to generate the image data 150; however, if the waveform return records selected based on the relevance score fail to satisfy the selection budget 140, additional waveform return records are added to the subset of waveform return records used to generate the image data 150 based on other factors, such as based on acquisition geometries.

As another example, one or more of the threshold(s) 142 may specify limitations related to a distribution of acquisition geometries about the observed area 108, such as a maximum spacing between receivers 118. In this example, the waveform record selector 138 adds waveform return records to the subset used to generate the image data 150 until the threshold(s) 142 are satisfied. In this example, if a count of waveform return records needed to satisfy the threshold(s) 142 is less than the selection budget 140, additional waveform return records are added to the subset used to generate the image data 150 until the selection budget 140 is satisfied. In other implementations, other combinations of the threshold(s) 142 and the selection budget 140 are used to select the subset of waveform return records used to generate the image data 150.

The image processor 144 uses one or more physics-based models 146, one or more machine-learning-based (“ML-based”) models 148, or both, to generate the image data 150 using the subset of waveform return records selected by the waveform record selector 138. For example, the physics-based model(s) 146 may include a reverse time migration (RTM) model that is configured to perform RTM or a variant thereof (e.g., least squares RTM) using the selected subset of waveform return records to generate the image data 150. As another example, the ML-based model(s) 148 may use a generative ML process, such as a generative-adversarial network (GAN) to generate the image data 150.

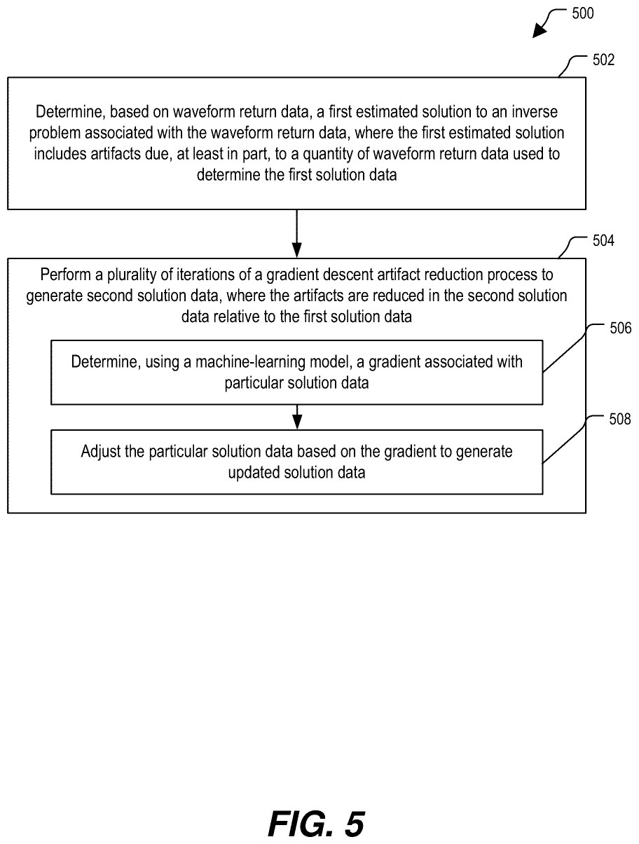

In yet another example, the physics-based model(s) 146 and ML-based model(s) 148 may cooperate to generate the image data 150. To illustrate, the physics-based model(s) 146 may be used to generate image data that is processed by the ML-based models 148 to improve the output image data 150, such as by reducing the number or severity of artifacts in the image data 150. As one non-limiting example, the ML-based model(s) 148 include a score matching network that is trained to perform a gradient descent artifact reduction process, as described further with reference to FIGS. 5-9C. As another example, the physics-based model(s) 146 may be used to generate a noisy image that is denoised by the ML-based model(s) 148, such as by using the noisy image as a reference image (also referred to as an “image prior”) for a deep image prior operation that uses early stopping to reduce artifacts in the image data 150. As yet another example, the physics-based model(s) 146 may be configured to refine output of the ML-based model(s) 148 to generate the image data 150. In still another illustrative example, the image processor 144 may use an iterative process to generate the image data 150, where each iteration (or some iterations) includes operations performed by the physics-based model(s) 146 and operations performed by the ML-based model(s) 148.

The system 100 is able to generate high-quality image data 150 (e.g., images that have fewer and/or weaker artifacts and adequate representation of regions of interest) using fewer waveform return records of the waveform return data 120 than would be used to make similar quality images without using the waveform record selection techniques disclosed herein. For example, selecting the subset of waveform return records that are used to generate the image data 150 based on expected information gain and a selection budget facilitates use of only the most relevant waveform return data 120 to generate the image data 150. Additionally, acquisition geometries can be used to facilitate even illumination of the area(s) of interest within the observed area 108. Further, the system 100 uses user configurable parameters (such as the selection budget 140, the threshold(s) 142, or both) to enable a user to limit computing resources used or to increase computing resource utilization in order to improve image quality. For example, a user may specify a relatively small selection budget 140 to enable generation of a lower quality image or may specify a somewhat higher selection budget 140 to improve image quality. In this example, the most relevant waveform return data 120 (based on the relevance score) are used for both the lower quality image and the improved image; however, addition of more high relevance waveform return records may facilitate artifact reduction in the image data 150. In either case, the system 100 conserves the use of computing resources by omitting waveform return data 120 that are least relevant (e.g., have the lowest relevance scores) from the subset of waveform return records used to generate the image data 150.

FIG. 2 is a diagram illustrating particular aspects of portions of the system 100 of FIG. 1 in accordance with some aspects of the present disclosure. In particular, FIG. 2 illustrates data received by and data generated by various portions of the inverse problem engine 130 in a particular implementation. In FIG. 2, the inverse problem engine 130 includes the preprocessor 132, the relevance score processor 134, the waveform record selector 138, and the image processor 144, each of which may operate as described with reference to FIG. 1.

In FIG. 2, the inverse problem engine 130 obtains the waveform return data 120 and the structure estimate 122. To illustrate, in some implementations, the preprocessor 132 of the inverse problem engine 130 receives the waveform return data 120, the structure estimate 122, or both, from the sensing system 102 of FIG. 1. In the same or different implementations, the preprocessor 132 retrieves the waveform return data 120, the structure estimate 122, or both, from a memory device, such as a data storage system associated with or coupled (directly or indirectly) to the sensing system 102 of FIG. 1.

In FIG. 2, the waveform return data 120 include a waveform return record 202 and one or more additional waveform return records. In the example illustrated in FIG. 2, the waveform return record 202 includes time-series data 204 representing the waveform returns 116 received at one or more receivers 118 of FIG. 1. Additionally, in FIG. 2, the waveform return record 202 includes or is associated with acquisition geometry data 206 indicating the positions of the receiver(s) 118 and the source(s) 104 relative to the observed area 108 of FIG. 1. Although FIG. 2 illustrates the waveform return record 202 including time-series data 204, in other implementations, the waveform return record 202 may include depth-domain data, image data, or both, instead of or in addition to the time-series data 204.

In the example illustrated in FIG. 2, the preprocessor 132 generates transformed waveform return data 208 based on the waveform return data 120. For example, the preprocessor 132 may generate depth-domain data 210 based on the waveform return record 202 via reverse time migration or ray tracing. Additionally, the preprocessor 132 of FIG. 2 uses a segmentation process to generate boundary data 212 representing, in the structure estimate 122, the boundary regions 112 of the subsurface layers 114 of the observed area 108.

In the example illustrated in FIG. 2, the relevance score processor 134 includes an information gain predictor 214, a ML-based relevance score model 220, or both. In a particular implementation, the information gain predictor 214 includes a structure estimate-waveform return record (“SW”) information gain predictor 216, a waveform return record-waveform return record (“WW”) information gain predictor 218, or both. The SW information gain predictor 216 is configured to estimate information gain of a particular waveform return record by comparison to the structure estimate 122. For example, the SW information gain predictor 216 may calculate a value of a metric that is indicative of information gain (e.g., a measure of mutual information) based on at least a portion of the waveform return record 202 and at least a portion of the structure estimate 122. To illustrate, based on the boundary data 212, the SW information gain predictor 216 may identify one or more regions of interest in the depth-domain data 210 representing the waveform return record 202 and one or more corresponding regions of interest of the structure estimate 122. The SW information gain predictor 216 may determine a value of the metric indicative of information gain based on a comparison (e.g., a pixel-by-pixel comparison) of the regions of interest of the depth domain data 210 and the structure estimate 122.

The WW information gain predictor 218 is configured to estimate information gain of a particular waveform return record relative to one or more other waveform return records of the waveform return data 120. For example, WW information gain predictor 218 may determine a value of a metric that is indicative of information gain (e.g., a measure of mutual information) based on a comparison (e.g., a pixel-by-pixel comparison) of the depth-domain data 210 associated with the waveform return record 202 and depth-domain data associated with another waveform return record of the waveform return data 120.

In a particular implementation, the ML-based relevance score model 220 is a trained model (e.g., a neural network) configured to receive input corresponding to the one or more waveform return records and to generate and output score data 222 for at least one of the one or more waveform return records. As one example, the ML-based relevance score model 220 includes a regression model that is configured and trained to receive as input the depth-domain data 210 (or a vector based on the depth-domain data 210) and the structure estimate 122 (or a vector based on the structure estimate 122) and to generate as output a value that indicates a relevance score 224 for the waveform return record 202. As another example, the ML-based relevance score model 220 includes a regression model that is configured and trained to receive as input the depth-domain data 210 (or a vector based on the depth-domain data 210) and data descriptive of one or more other waveform return records (e.g., depth-domain data associated with the other waveform return record(s)) and to generate as output a relevance score value for the waveform return record 202.

In some implementations, the input data of the ML-based relevance score model 220 includes time-series data (e.g., the time-series data 204) rather than or in addition to depth-domain data. For example, the ML-based relevance score model 220 may be configured to receive as input the time-series data 204 and the structure estimate 122 (or a vector based on the structure estimate 122) and to generate as output a value that indicates the relevance score 224 for the waveform return record 202. In some implementations, data representing the waveform return record 202 and data representing the structure estimate 122 are aggregated or combined to generate input data for the ML-based relevance score model 220. In other implementations, the data representing the waveform return record 202 and the data representing the structure estimate 122 are provided separately (e.g., sequentially) as input to the ML-based relevance score model 220.

The waveform record selector 138 is configured to select (based on the selection budget 140, the threshold(s) 142, or both) a subset of the waveform return data 120 that are to be used to generate the image data 150. In the example illustrated in FIG. 2, the waveform record selector 138 divides the waveform return data 120 into three distinct (e.g., mutually exclusive) subsets, including a first subset of waveform return records 230, a second subset of waveform return records 232, and a third subset of waveform return records 234. In this example, the first subset of waveform return records 230 includes a subset of the waveform return data 120 selected based on estimated information gain (e.g., based on the score data 222), the second subset of waveform return records 232 includes a subset of the waveform return data 120 that are selected to be distributed about the observed area 108 (e.g., based on the acquisition geometry), and the third subset of waveform return records 234 includes a remainder of the waveform return data 120 that are not used to generate the image data 150. The selection budget 140 may specify a count of waveform return records to be included in the first subset of waveform return records 230, in the second subset of waveform return records 232, in the third subset of waveform return records 234, or any combination thereof. Additionally, or alternatively, the threshold(s) 142 may specify criteria that a waveform return record must satisfy to be included in the first subset of waveform return records 230, in the second subset of waveform return records 232, in the third subset of waveform return records 234, or any combination thereof.

In a particular implementation, the waveform record selector 138 selects the second subset of waveform return records 232 to facilitate a substantially (e.g., within specified tolerances) even distribution of illumination of one or more regions of interest in the observed area 108. As one example, the waveform record selector 138 selects the second subset of waveform return records 232 based exclusively or primarily on the acquisition geometries of the waveform return data 120. To illustrate, the selection budget 140 may indicate that four waveform return records are to be included in the second subset of waveform return records 232, and the waveform record selector 138 may select four waveform return records to include in the second subset of waveform return records 232 based on which waveform return records of the waveform return data 120 are expected to best illuminate each of four regions of the observed area 108 based on the acquisition geometries.

As another example, the waveform record selector 138 selects the second group of waveform return records 232 based on the acquisition geometries of the waveform return data 120 and based on estimated information gain associated with the waveform return records. To illustrate, after one or more waveform return records are added to the second subset of waveform return records 232, the waveform record selector 138 may determine whether to add another particular waveform return record to the second subset of waveform return records 232 based on whether the particular waveform return record is expected to add significant information (e.g., is associated with a significant information gain) relative to the waveform return record(s) already included in the second subset of waveform return records 232.

In a particular implementation, the waveform record selector 138 selects the first subset of waveform return records 230 to have high information gain relative to the structure estimate 122, relative to other waveform return records already included in the first subset of waveform return records 230, or both. For example, the relevance score 224 for the waveform return record 202 may be equal to or proportional to a value of a measure of mutual information (or another information gain metric) between waveform return record 202 and the structure estimate 122. In this example, the waveform record selector 138 may determine whether to add the waveform return record 202 to the first subset of waveform return records 230 based on whether the relevance score 224 is greater than relevance scores of one or more other waveform return records of the waveform return data 120.

In a particular implementation, the selection budget 140 specifies a count of waveform return records to be included in the first subset of waveform return records 230, and the waveform record selector 138 adds waveform return data 120 associated with the largest relevance score values to the first subset of waveform return records 230 until the count is satisfied. To illustrate, if the selection budget 140 indicates that nine waveform return records are to be included in the first subset of waveform return records 230, the waveform record selector 138 may sort the score data 222 in order of descending relevance score values and select the top nine waveform return records for inclusion in the first subset of waveform return records 230.

In a particular implementation, the threshold(s) 142 specify a minimum relevance score value that a waveform return record should have to be included in the first subset of waveform return records 230. In such implementations, the waveform record selector 138 adds waveform return data 120 associated with relevance score values that satisfy the minimum relevance score value to the first subset of waveform return records 230. In some such implementations, the selection budget 140 may indicate a maximum count of waveform return records to be added to the first subset of waveform return records 230. For example, the waveform record selector 138 may add waveform return records associated with the relevance score values that satisfy the minimum relevance score value to the first subset of waveform return records 230 until the selection budget 140 is satisfied. In this example, the waveform record selector 138 may add the waveform return data 120 associated with the relevance score values that satisfy the minimum relevance score value to the first subset of waveform return records 230 in order of descending relevance score such that the waveform return records added to the first subset of waveform return records 230 are those associated with the largest relevance score values. Additionally, or alternatively, the selection budget 140 may indicate a minimum count of waveform return records to be added to the first subset of waveform return records 230. For example, the waveform record selector 138 may add at least the waveform return data 120 associated with the largest relevance score values to the first subset of waveform return records 230 until at least the minimum count from the selection budget 140 is satisfied.

In some implementations, the waveform record selector 138 selects the first subset of waveform return records 230 and subsequently selects the second subset of waveform return records 232 from the remaining waveform return records of the waveform return data 120. In other implementations, the waveform record selector 138 selects the second subset of waveform return records 232 and subsequently selects the first subset of waveform return records 230 from the remaining waveform return records of the waveform return data 120. In some implementations, the third subset of waveform return records 234 represents those waveform return records of the waveform return data 120 that the waveform record selector 138 did not include in the first subset of waveform return records 230 and did not include in the second subset of waveform return records 232.

In the example illustrated in FIG. 2, the first subset of waveform return records 230 and the second subset of waveform return records 232, together, correspond to the subset of waveform return records used to form the image data 150, and the third subset of waveform return records 234 corresponds to a subset of the waveform return data 120 that are not used to form the image data 150. Due to operation of the waveform record selector 138, the third subset of waveform return records 234 includes one or more of the waveform return records of the waveform return data 120. That is, at least some of the waveform return data 120 are omitted from operations to form the image data 150. Thus, processing resources that would be used to process the third subset of waveform return records 234 are conserved.

Although FIG. 2 illustrates the waveform record selector 138 selecting both the first subset of waveform return records 230 and the second subset of waveform return records 232, in other implementations, the waveform record selector 138 omits selection of the second subset of waveform return records 232. For example, the waveform record selector 138 may select only the first subset of waveform return records 230, in which case the second subset of waveform return records 232 is merged with the third subset of waveform return records 234 and omitted from processing to form the image data 150. In some such implementations, a user configurable setting may indicate whether the waveform record selector 138 selects the second subset of waveform return records 232 or omits selection of the second subset of waveform return records 232. For example, the selection budget 140 may be user configurable to indicate a count of waveform return records to be included in the second subset of waveform return records 232. In this example, if the count of waveform return records to be included in the second subset of waveform return records 232 has a value of zero, the waveform record selector 138 forgoes selection of the second subset of waveform return records 232. In contrast, in this example, if the count of waveform return records to be included in the second subset of waveform return records 232 has a non-zero value, the waveform record selector 138 includes one or more waveform return records in the second subset of waveform return records 232.

The image processor 144 is configured to generate the image data 150 based on the subset of waveform return records selected by the waveform record selector 138, such as the first subset of waveform return records 230 or both the first and second subsets of waveform return records 230, 232. As described with reference to FIG. 1, the image processor 144 may use one or more physics-based models 146, one or more ML-based models 148, or both, to generate the image data 150.

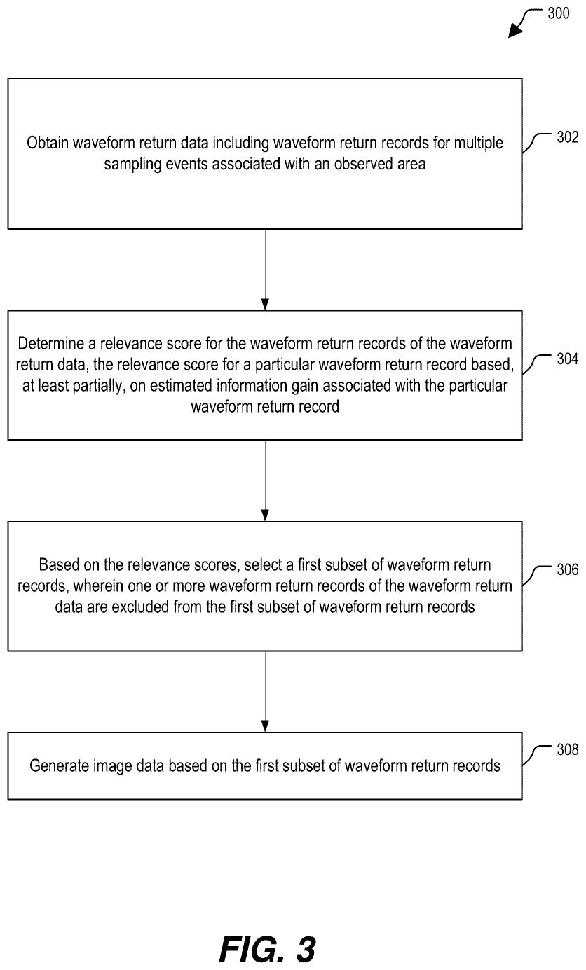

FIG. 3 illustrates a flow chart of an example of a method of generating image data using a selected subset of available waveform return data in accordance with some aspects of the present disclosure. One or more operations described with reference to FIG. 3 may be performed by the system 100, such as by one or more computing devices executing instructions corresponding to the inverse problem engine 130. To illustrate, one or more of the operations described with reference to FIG. 3 may be performed by the computer system 400 of FIG. 4, such as by processor(s) 402 executing instructions 444.

The method 300 includes, at block 302, obtaining waveform return data including waveform return records for multiple sampling events associated with an observed area. For example, the inverse problem engine 130 of FIGS. 1 and 2 may receive the waveform return data 120 from the sensing system 102 or from another device or memory associated with the sensing system 102. In some implementations, the waveform return data 120 correspond to a plurality of waveform return records indicative of reflections, from visually occluded structures (e.g., the structures 110), of one or more incident waves. In some implementations, the inverse problem engine 130 also receives the structure estimate 122 that includes information indicating estimated locations of the visually occluded structures. In some implementations, the waveform return data 120 represent waveform returns associated with multiple different acquisition geometries, where each acquisition geometry corresponds to one or more source locations and one or more receiver locations relative to the observed area 108.

The method 300 also includes, at block 304, determining a relevance score for the waveform return records of the waveform return data. The relevance score for a particular waveform return record is based, at least partially, on estimated information gain associated with the particular waveform return record. The information gain may be estimated, for example, based on a measure of mutual information between waveform return records or between a waveform return record and the structure estimate 122. In other examples, the information gain may be estimated based on a cross correlation distance, a mean square error reduction, another information gain metric, or a combination thereof.

In some implementations, the relevance score is determined based on transformed waveform return data, such as depth-domain data and/or image data representing each waveform return record. For example, the method 300 may include generating image data (e.g., using reverse time migration or ray tracing) based on the particular waveform return record before determining the relevance score for the particular waveform return record. In this example, the information gain associated with the waveform return record may be estimated based on a comparison of the image data to image data representing the structure estimate 122 and/or image data representing other waveform return records.

The method 300 further includes, at block 306, based on the relevance scores, selecting a first subset of waveform return records. One or more waveform return records of the waveform return data 120 are excluded from the first subset of waveform return records. For example, the first subset of waveform return records includes two or more waveform return records of the waveform return data 120 and excludes one or more other waveform return records of the waveform return data 120.

As one particular example, where mutual information is used as an indicator of information gain, waveform return records that are included in the first subset of waveform return records may be selected based on mutual information with respect to the structure estimate 122 and based on mutual information with respect to one another. For example, a value of the relevance score may be directly proportional to a first measure of mutual information of a particular waveform return record with respect to the structure estimate 122 and inversely proportional to a second measure of mutual information of the particular waveform return record with respect to one or more other waveform return records of the available waveform return data 120. To illustrate, selecting the first subset of waveform return records may include designating a set of waveform return records for inclusion in the first subset of waveform return records 230 and designating one or more other sets of waveform return records (e.g., waveform return records of the third subset of waveform return records 234) for omission from the first subset of waveform return records 230. In this illustrative example, the set of waveform return records designated for including in the first subset of waveform return records 230 may have high mutual information with respect to the structure estimate 122 and low mutual information with respect to one another. Further, in this illustrative example, one or more other waveform return records that have low mutual information with respect to the structure estimate 122 may be omitted from the first subset of waveform return records 230. Additionally or in the alternative, in this illustrative example, one or more other waveform return records that have high mutual information with respect to one another and/or with respect to one or more waveform return records already included in the first subset of waveform return records 230 may be omitted from the first group of waveform return records 230.

In some implementations, the relevance score for each waveform return record may be based on information gain with respect to only a portion of the structure estimate 122. For example, the method 300 may include identifying one or more regions of interest in the structure estimate 122, and the relevance score for each waveform return record may be based on mutual information (or another metric indicative of information gain) with respect to the one or more regions of interest. The regions of interest may correspond to, for example, regions around boundaries between subsurface layers. In this example, identifying one or more regions of interest may include segmenting the structure estimate 122 to identify boundaries between subsurface layers and, for an identified boundary, designating a region on either side of the identified boundary as a region of interest. In some implementations the relevance score for each waveform return record may be based on mutual information (or another metric indicative of information gain) with respect to a region of interest of the structure estimate 122. In some such implementations, mutual information for locations within the regions of interest may be weighted more heavily than mutual information for locations outside the regions of interest to determine the relevance score for the particular waveform return record.

In some implementations, the method 300 also includes selecting a second subset of waveform return records based on the acquisition geometries of the sampling events used to generate the waveform return data. In such implementations, the second subset of waveform return records is a proper subset of the available waveform return data 120. For example, the second subset of waveform return records 232 includes two or more waveform return records and excludes one or more waveform return records of the waveform return data 120. In some such implementations, the second subset of waveform return records 232 is selected irrespective of information gain. For example, the second subset of waveform return records 232 may be selected, based on the acquisition geometries, to be distributed about the observed area 108. In this example, the first subset of waveform return records 230 and the second subset of waveform return records 232 are mutually exclusive. To illustrate, the second subset of waveform return records 232 may be selected to be distributed about the observed area 108, and the first subset of waveform return records 230 may be selected from among the set of available waveform return records that are not included in the second subset of waveform return records 232.

In some implementations, a number of waveform return records selected for inclusion in the first subset of waveform return records 230, a number of waveform return records selected for inclusion in the second subset of waveform return records 232, or a number of waveform return records selected for inclusion in the combined first and second groups of waveform return records 230, 232 is based on a selection budget. For example, the selection budget 140 of FIGS. 1 and 2 may specify a threshold 142 count of waveform return records to be included in the first subset of waveform return records 230. As another example, the selection budget 140 of FIGS. 1 and 2 may specify a threshold 142 count of waveform return records to be included in the second subset of waveform return records 232. As still another example, the selection budget 140 may specify a threshold 142 count of waveform return records to be used to generate the image data 150, where the waveform return records to be used to generate the image data include both the first subset of waveform return records 230 and the second subset of waveform return records 232.

The method 300 also includes, at block 308, generating image data based on at least the first subset of waveform return records. The image data may also be generated based on the second subset of waveform return records. For example, the image processor 144 may generate the image data 150 based on the first subset of waveform return records 230 or based on the first and second subsets of waveform return records 230, 232. To illustrate, the image processor 144 may generate the image data 150 by subjecting the first subset of waveform return records 230 to a gradient decent artifact reduction process, as described further with reference to FIGS. 5-9C. In other examples, the image processor 144 generates the image data 150 using another machine-learning based process or a physics based process. In some implementations, the image data 150 may also be based on the second subset of waveform return records.

The method 300 enables generation of similar quality images to those generated using larger numbers of waveform return records by selecting the waveform return records to be used based on information gain and optionally based on acquisition geometries associated with the waveform return records.

FIG. 4 illustrates an example of a computer system 400 configured to generate image data based on a selected subset of available waveform return data in accordance with some aspects of the present disclosure. For example, the computer system 400 is configured to initiate, perform, or control one or more of the operations described with reference to FIGS. 1-3. The computer system 400 can be implemented as or incorporated into one or more of various other devices, such as a personal computer (PC), a tablet PC, a server computer, a personal digital assistant (PDA), a laptop computer, a desktop computer, a communications device, a wireless telephone, or any other machine capable of executing a set of instructions (sequential or otherwise) that specify actions to be taken by that machine. Further, while a single computer system 400 is illustrated, the term “system” includes any collection of systems or sub-systems that individually or jointly execute a set, or multiple sets, of instructions to perform one or more computer functions. While FIG. 4 illustrates one example of the computer system 400, other computer systems or computing architectures and configurations may be used for carrying out the operations disclosed herein.

The computer system 400 includes one or more processors 402. Each processor of the one or more processors 402 can include a single processing core or multiple processing cores that operate sequentially, in parallel, or sequentially at times and in parallel at other times. Each processor of the one or more processors 402 includes circuitry defining a plurality of logic circuits 404, working memory 406 (e.g., registers and cache memory), communication circuits, etc., which together enable the processor(s) 402 to control the operations performed by the computer system 400 and enable the processor(s) 402 to generate a useful result based on analysis of particular data and execution of specific instructions.

The processor(s) 402 are configured to interact with other components or subsystems of the computer system 400 via a bus 470. The bus 470 is illustrative of any interconnection scheme serving to link the subsystems of the computer system 400, external subsystems or devices, or any combination thereof. The bus 470 includes a plurality of conductors to facilitate communication of electrical and/or electromagnetic signals between the components or subsystems of the computer system 400. Additionally, the bus 470 includes one or more bus controllers or other circuits (e.g., transmitters and receivers) that manage signaling via the plurality of conductors and that cause signals sent via the plurality of conductors to conform to particular communication protocols.

In FIG. 4, the computer system 400 includes one or more output devices 430, one or more input devices 410, and one or more interface devices 420. Each of the output device(s) 430, the input device(s) 410, and the interface device(s) 420 can be coupled to the bus 470 via a port or connector, such as a Universal Serial Bus port, a digital visual interface (DVI) port, a serial ATA (SATA) port, a small computer system interface (SCSI) port, a high-definition media interface (HDMI) port, or another serial or parallel port. In some implementations, one or more of the output device(s) 430, the input device(s) 410, and/or the interface device(s) 420 is coupled to or integrated within a housing with the processor(s) 402 and the memory device(s) 440, in which case the connections to the bus 470 can be internal, such as via an expansion slot or other card-to-card connector. In other implementations, the processor(s) 402 and the memory device(s) 440 are integrated within a housing that includes one or more external ports, and one or more of the output device(s) 430, the input device(s) 410, and/or the interface device(s) 420 is coupled to the bus 470 via the external port(s).

Examples of the output device(s) 430 include display devices, speakers, printers, televisions, projectors, or other devices to provide output of data (e.g., an image 434 representing the image data 150 of FIG. 1) in a manner that is perceptible by a user. Examples of the input device(s) 410 include buttons, switches, knobs, a keyboard 412, a pointing device 414, a biometric device, a microphone, a motion sensor, or another device to detect user input actions. The pointing device 414 includes, for example, one or more of a mouse, a stylus, a track ball, a pen, a touch pad, a touch screen, a tablet, another device that is useful for interacting with a graphical user interface, or any combination thereof. A particular device may be an input device 410 and an output device 430. For example, the particular device may be a touch screen.

The interface device(s) 420 are configured to enable the computer system 400 to communicate with one or more other devices 424 directly or via one or more networks 422. For example, the interface device(s) 420 may encode data in electrical and/or electromagnetic signals that are transmitted to the other device(s) 424 as control signals or packet-based communication using pre-defined communication protocols. As another example, the interface device(s) 420 may receive and decode electrical and/or electromagnetic signals that are transmitted by the other device(s) 424. To illustrate, the other device(s) 424 may include sensor(s) that generate the waveform return data 120. The electrical and/or electromagnetic signals can be transmitted wirelessly (e.g., via propagation through free space), via one or more wires, cables, optical fibers, or via a combination of wired and wireless transmission.

The computer system 400 also includes the one or more memory devices 440. The memory device(s) 440 include any suitable computer-readable storage device depending on, for example, whether data access needs to be bi-directional or unidirectional, speed of data access required, memory capacity required, other factors related to data access, or any combination thereof. Generally, the memory device(s) 440 includes some combinations of volatile memory devices and non-volatile memory devices, though in some implementations, only one or the other may be present. Examples of volatile memory devices and circuits include registers, caches, latches, many types of random-access memory (RAM), such as dynamic random-access memory (DRAM), etc. Examples of non-volatile memory devices and circuits include hard disks, optical disks, flash memory, and certain types of RAM, such as resistive random-access memory (ReRAM). Other examples of both volatile and non-volatile memory devices can be used as well, or in the alternative, so long as such memory devices store information in a physical, tangible medium. Thus, the memory device(s) 440 include circuits and structures and are not merely signals or other transitory phenomena (i.e., are non-transitory media).

In the example illustrated in FIG. 4, the memory device(s) 440 store instructions 444 that are executable by the processor(s) 402 to perform various operations and functions. The instructions 444 include instructions to enable the various components and subsystems of the computer system 400 to operate, interact with one another, and interact with a user, such as a basic input/output system (BIOS) 446 and an operating system (OS) 448. Additionally, the instructions 444 include one or more applications 450, scripts, or other program code to enable the processor(s) 402 to perform the operations described herein. For example, in FIG. 4, the instructions 444 include inverse problem engine instructions 452 that are executable by the processor(s) 402 to initiate, perform, or control any of the operations of the inverse problem engine 130 described with reference to FIGS. 1-3. As another example, in FIG. 4, the instructions 444 include preprocessing instructions 454 that are executable by the processor(s) 402 to initiate, perform, or control any of the operations of the preprocessor 132 described with reference to FIGS. 1-3. As another example, in FIG. 4, the instructions 444 include relevance score calculation instructions 456 that are executable by the processor(s) 402 to initiate, perform, or control any of the operations of the relevance score processor 134 described with reference to FIGS. 1-3. As another example, in FIG. 4, the instructions 444 include waveform return selection instructions 458 that are executable by the processor(s) 402 to initiate, perform, or control any of the operations of the waveform record selector 138 described with reference to FIGS. 1-3. As another example, in FIG. 4, the instructions 444 include image processing instructions 460 that are executable by the processor(s) 402 to initiate, perform, or control any of the operations of the image processor 144 described with reference to FIGS. 1-3. In FIG. 4, the instructions 444 also include a graphical user interface (GUI) engine 462 that includes instructions that are executable by the processor(s) 402 to generate a GUI 432 including the image 434 corresponding to the image data 150.

As one example, the image processing instructions 460, when executed by the processor(s) 402 cause the processor(s) 402 to initiate, perform, or control an iterative process in which a physics-based model generates first image data, based on a selected subset of the waveform return data 120, and provides the first image data as input to one or more machine-learning models to generate the image data 150 via a gradient descent artifact reduction process. The gradient descent artifact reduction process may use a plurality of iterations to generate image data 150.

In a particular implementation, an iteration of the gradient descent artifact reduction process includes determining, using one of the ML-based model(s) 148 of FIG. 1, a gradient associated with particular solution data (e.g., the initial solution data or solution data generated by a prior iteration of the gradient descent artifact reduction process). The iteration also includes adjusting the particular solution data based on the gradient to generate updated solution data.

As one example, the image processor 144 may perform operations as described by the following pseudocode. In the following pseudocode, a “shot” refers to a single sampling event, measurements from which may be used to generate a corresponding set of waveform return data. In other contexts (e.g., other than seismic imaging) shots may be replaced with other sampling events (e.g., pings in the context of sonar).

```
x₀ ← RTM(k)
for n iterations:
  for m artifact levels:
    αₘ = ε*λₘ/λₘᵢₙ
    for t=1,..T Langevin steps:
      xₜ ← xₜ₋₁ + αₘ S(xₜ₋₁, λₘ) + noise
  Optional or selective, for p shots:
    Perform physics-based modeling to generate revised xₜ
```

In the pseudocode above, RTM (k) represents an aggregation of k reverse time migration results (e.g., a combined image based on k images, each based on waveform return data for a respective shot), where k is an integer greater than one. For example. RTM (8) refers to solution data based on reverse time migration of 8 waveform return measurements of the waveform return data 120. The solution data generated by RTM (k) is used as an initial estimate (x₀) of a solution to the inverse problem. Additionally, in the pseudocode above, n is a configurable counter having a value greater than or equal to one. Further, in the pseudocode above, m is a counter indicating a number of artifact levels over which operations are performed, where m is an integer greater than or equal to one and less than or equal to a count of the total number of shots represented in the waveform return data 120 or that are otherwise available. In this context, an “artifact level” refers to any metric that characterizes and distinguishes the number, distribution, and/or intensity of migration swing artifacts in a set of images. Generally, m is set within a range from a smallest number of shots (referred to as kₘᵢₙ) that can be used to generate acceptable solution data to a largest number of shots (referred to as kₘₐₓ) that the image processor 144 is allowed to use. In a particular implementation, kₘᵢₙ is associated with a largest artifact level, λₘₐₓ (e.g., strongest artifacts in the solution data) used to train or optimize the ML-based model(s) 148, and kₘₐₓ is associated with a smallest artifact level, λₘᵢₙ (e.g., weakest artifacts in the solution data) used to train or optimize the ML-based model(s) 148.

Additionally, in the pseudocode above, αₘ is a step size parameter used by the Langevin operations in the inner loop and is annealed (e.g., iteratively decreased) based on a ratio of the current artifact level, λₘ, to the smallest artifact level, λₘᵢₙ, used to train or optimize the ML-based model(s) 148 adjusted by a configurable parameter ε.

Further, in the pseudocode above, an inner loop performs T iterations to modify the solution data x to decrease artifacts present in the solution data, where T is an integer greater than or equal to two. Generally, good results have been achieved with values of T on the order of 100 to 200. In each inner loop iteration, solution data x, is determined by adjusting prior solution data xₜ₋₁ based on a gradient αₘ S (xₜ₋₁, λₘ), and where S (xₜ₋₁, λₘ) is an output of the ML-based model(s) 148 based on the prior solution data xₜ₋₁ and the current artifact level, λₘ.

In some implementations, after T iterations of the inner loop to generate solution data xₜ, the solution data may be adapted to satisfy particular constraints. In some implementations, the solution data is adapted to conform the solution data to specified expectations, such as physical constraints of the observed system. Such adaptation of the solution data is optional. To illustrate, such adaptation can be omitted entirely in some implementations. In some implementations, adaptation of the solution data is selectively performed. To illustrate, particular solution data may be adapted to conform to specified constraints based on characteristics of the solution data or based on output of one or more the operations performed by the pseudocode.

In some implementations, the pseudocode above also includes one or more iterations of the physics-based model(s) 146. For example, within the n iterations loop and after the T Langevin steps loop, the pseudocode may include performing one or more least mean square reverse time migration (LSRTM) iterations of p shots, where p is an integer greater than one. In some implementations, p is set equal to k. In some implementations, physics-based modelling after the T Langevin steps loop is optional. To illustrate, physics-based modelling can be omitted entirely in some implementations. In some implementations, physics-based modelling after the T Langevin steps loop is selectively performed. To illustrate, physics-based modelling may be performed based on characteristics of the solution data generated by the T Langevin steps loop or based on output of another operation performed by the pseudocode.

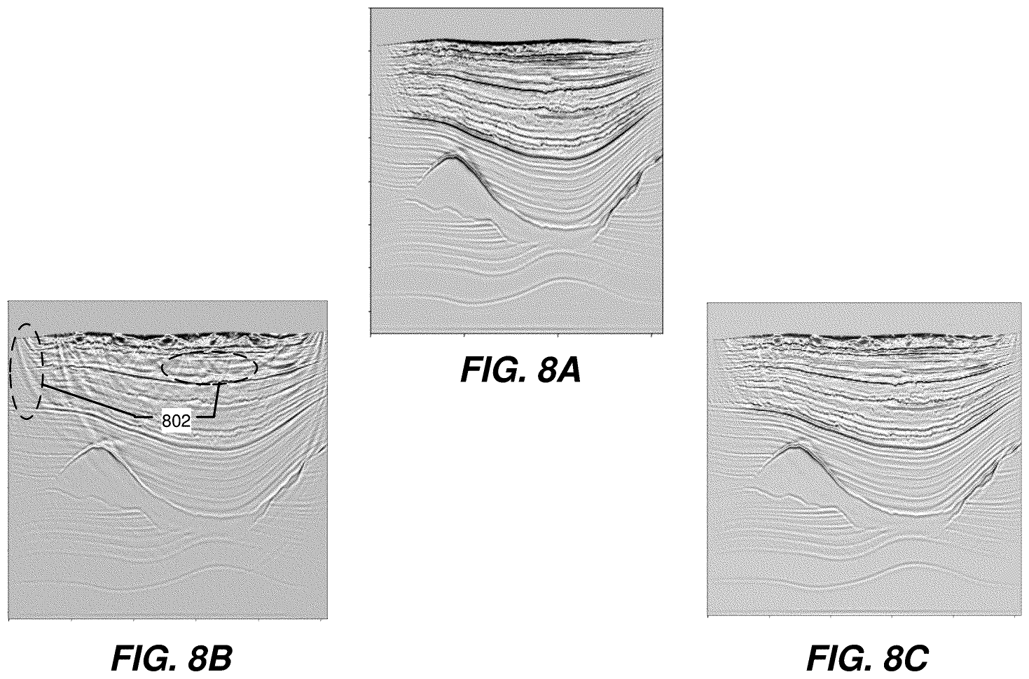

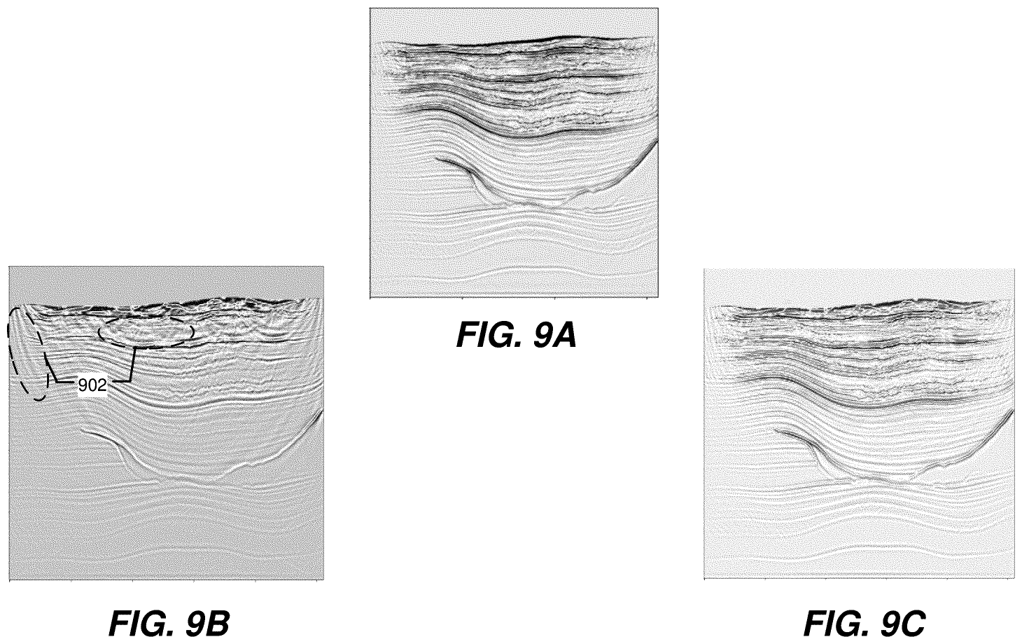

One benefit of using a gradient descent artifact reduction process based on the pseudocode above is that high-quality solutions (e.g., solutions with weaker or fewer artifacts) can be generated using fewer computing resources than would be used to generate similar high-quality solutions using reverse time migration alone. To illustrate, the images illustrated in FIGS. 8A-8C and 9A-9C show examples of results based on simulated seismic sensing. As explained above, in the context of seismic sensing and imaging, sampling events are generally referred to as “shots”, and waveform return measurements associated with each shot correspond to waveform return data for the shot. However, in other sensing contexts, sampling events may be referred to using different terminology.

FIGS. 8A and 9A show images that were each generated using only reverse time migration based on 243 shots. FIGS. 8B and 9B show images that were each generated using only reverse time migration based on 8 shots. Note that in FIG. 8B, significant visual artifacts are present in regions 802. Significant visual artifacts are also present in FIG. 9B in regions 902. FIGS. 8C and 9C show images that were each generated using reverse time migration based on 8 shots and a gradient descent artifact reduction process based on the pseudocode above. To generate FIGS. 8C and 9C, n was set to 1, m was set to 1 and T was set to 200, R was zeroed out, and no LSRTM iterations were performed after the T Langevin steps loop.

Comparison of FIG. 8B with FIG. 8C shows that the gradient descent artifact reduction process significantly reduced the number and/or visual strength of the artifacts present in FIG. 8C as compared to the artifacts present in FIG. 8B. Likewise, comparison of FIG. 9B with FIG. 9C shows that the gradient descent artifact reduction process significantly reduced the number and/or visual strength of the artifacts present in FIG. 9C as compared to the artifacts present in FIG. 9B. For many purposes, FIGS. 8C and 9C may be useful substitutes for FIGS. 8A and 9A; however, generation of FIGS. 8C and 9C used significantly fewer computing resources (e.g., power, processor cycles, memory) than generation of FIGS. 8A and 9A. Further, significant time and expense can be saved by generating only the 8 shots used for FIGS. 8C and 9C rather than the 243 shots as used for FIGS. 8A and 9A.

Returning to FIG. 4, in a particular implementation, the image processing instructions 460 may include instructions to execute a score-matching network. The score-matching network may be trained, for example, by obtaining multiple sets of solution data based on waveform return measurements (e.g., the waveform return data 120). In this example, each set of solution data corresponds to a physics-based solution to the inverse problem, and each set of solution data is associated with a respective artifact level. In general, the artifact level of a set of solution data can be reduced by using waveform return data from a larger number of sampling events (e.g., more shots). Multiple sets of training data are generated based on the multiple sets of solution data. For example, each set of training data is based on one or more sets of solution data associated with a respective artifact level. To illustrate, a set of training data associated with a particular artifact level is determined based on differences between a set of solution data associated with a lowest artifact level and a set of solution data with the particular artifact level.

The score matching network is trained using the multiple sets of training data. For example, the score matching network may be trained by adjusting parameters of the score matching network to decrease a value of an objective function. In this example, the value of the objective function represents a weighted sum of values of objective functions for multiple different artifact levels. To illustrate, the objective function for a particular artifact level λ may be represented by:

$$ℓ ( θ ; k ) = \frac{1}{2} {𝔼}_{{p}_{data} ( x )} {𝔼}_{RTM ( k )} [ {‖ {s}_{θ} ( \tilde{x} , λ ) + \frac{{x}_{RTM ( K )} - {x}_{RTM ( k )}}{{λ}_{k}^{2}} ‖}_{2}^{2} ]$$

In this example, the objective function used to train or optimize the score matching network may be represented by:

$$ℒ ( θ ; {\{ k \}}_{i = 1}^{L} ) = \frac{1}{L} {\sum }_{i = 1}^{L} γ ( {λ}_{{k}_{i}}^{2} ) ℓ ( θ ; {λ}_{i} )$$

In the objective function for a particular artifact level 2, Pdata (x) refers to a probability density function of a data set x and [symbol] p_{data}(x) represents an expectation over P_{data} (x) and [symbol] _{RTM (k)} represents an expectation over the set of images that are produced (e.g., an expectation over each allowed k value and over each set of specific images from the set of available data that are used to generate the k shots). S_{θ}(\tilde{x},λ) represents solution data generated by the ML-based model(s) 148 for a particular artifact level λ. Further, X_{RTM (K)} represents solution data generated by a physics-based model (e.g., RTM) based on K shots, where K is a count of shots of the largest set of shots used for any solution in the training data, and XRTM (k) represents solution data generated by the physics-based model (e.g., RTM) based on k shots, where k is an integer greater than one and less than K.

$$\frac{{x}_{RTM ( K )} - {x}_{RTM ( k )}}{{λ}_{k}^{2}}$$

represents a value of an error metric that is based on a difference between solution data associated with the particular artifact level (corresponding to using k shots) and solution data associated with a lowest artifact level (corresponding to using K shots) of the multiple sets of solution data used to generate the training data.

In the objective function used to train or optimize the score matching network, L is the total count of artifact levels used, and γ is a function of a fitting parameter that is based on an error metric associated with the particular artifact level. In some implementations, γ is equal to λ².

In a particular implementation, values of λ for a particular count of shots can be determined by determining multiple RTM (k) solutions for the same value of k. For example, from among a large set of waveform return data 120, multiple subsets of k shots can be selected. To illustrate, in the example of seismic sampling, different source and/or receiver positions can be selected for different subsets of k shots. The RTM (k) values for a particular value of k can be compared to RTM (K) to determine a mean square error for the artifact level associated with k. The value of A for the particular count of shots k can be determined by fitting a parameterized function to the mean square error values with respect to a normalized count of shots (e.g., kₘᵢₙ/k).

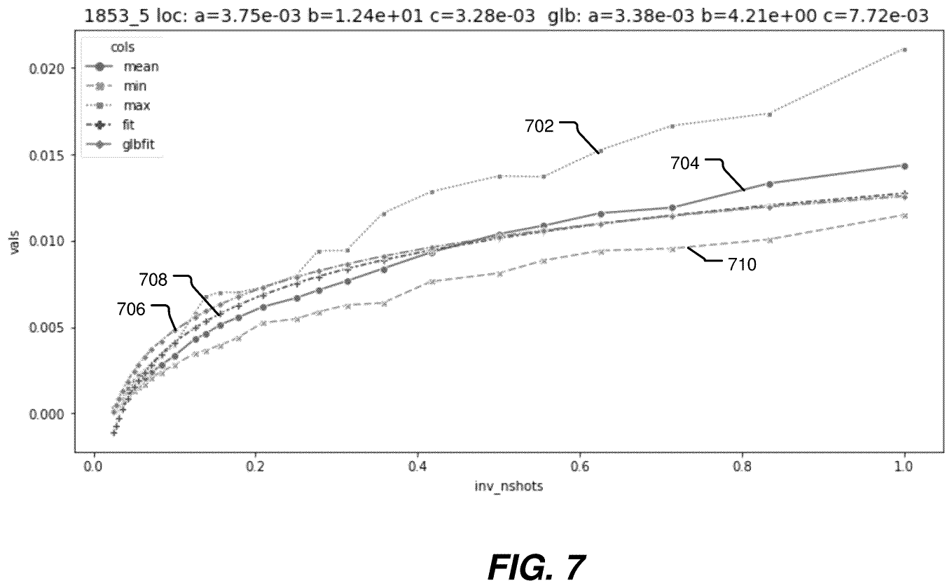

FIG. 7 is a diagram illustrating particular aspects of determining parameters of a gradient descent artifact reduction system. In particular, FIG. 7 illustrates a plot of data points with kₘᵢₙ/k on the x-axis and mean square error (MSE) of RTM (K) RTM (k) on the y-axis. In FIG. 7, lines 702, 704, 708, and 710 represent data for a particular slice (e.g., a two-dimensional visualization) of an observed system. For example, a line 702 connects maximum MSE (RTM (K) RTM (k)) values for the slice, a line 710 connects minimum MSE (RTM (K) RTM (k)) values for the slice, a line 704 connects values of a mean of a distribution of values of the MSE (RTM (K) RTM (k)) for the slice, and a line 708 represents a curve fit to values connected by the line 704. A line 706 represents a curve fit based on averaging across multiple slices. The line 706 represents values of 22.

In an alternative embodiment, dedicated hardware implementations, such as application specific integrated circuits, programmable logic arrays and other hardware devices, can be constructed to implement one or more of the operations described herein. Accordingly, the present disclosure encompasses software, firmware, and hardware implementations.

FIG. 5 is a flow chart of an example of a method of reducing artifacts in solution data (e.g., image data) associated with an inverse problem. One or more operations described with reference to FIG. 5 may be performed by the computer system 400 of FIG. 4, such as by the processor(s) 402 executing the instructions 444.

The method 500 includes, at 502, determining, using a physics-based model and based on waveform return data, first solution data. The first solution data is descriptive of a first estimated solution to an inverse problem associated with the waveform return data. The first solution data includes artifacts due, at least in part, to the quantity of waveform return data used to determine the first solution data.

As a particular example, the waveform return data may include waveform return measurements (e.g., waveform return records) associated with one or more seismic imaging shots. In this particular example, the first solution data may be determined by performing one or more iterations of reverse time migration based on the waveform return measurements associated with the one or more seismic imaging shots. In this example, the first estimated solution to the inverse problem may include a reflectivity image. In other examples, the waveform return data may be associated with other waveform-based measurement systems, such as sonar, lidar, or radar.

The method 500 also includes, at 504, performing a plurality of iterations of a gradient descent artifact reduction process to generate second solution data. The artifacts are reduced in the second solution data relative to the first solution data. A particular iteration of the gradient descent artifact reduction process includes, at 506, determining, using a machine-learning model (e.g., a score-matching network, such as the ML-based model(s) 148), a gradient associated with particular solution data, and at 508, adjusting the particular solution data based on the value of the gradient to generate updated solution data.

In some implementations, the method 500 also includes, after determining the second solution data, providing the second solution data as input to the physics-based model to generate third solution data. For example, a result generated by the Langevin steps of the pseudocode above may be subjected to one or more LSRTM iterations to further refine the solution. In some such implementations, the method 500 may further include, performing a second plurality of iterations of the gradient descent artifact reduction process to generate fourth solution data, where the artifacts are reduced in the fourth solution data relative to the third solution data.

In some implementations, during the particular iteration of the gradient descent artifact reduction process, the particular solution data is adjusted further based on a step size parameter (e.g., αₘ). Further, the step size parameter may be adjusted after one or more iterations. For example, the gradient descent artifact reduction process may include, after performing the plurality of iterations, adjusting the step size parameter and performing a second plurality of iterations using the adjusted step size parameter. In a particular aspect, the step size parameter is based on a ratio of an error metric associated with a count of waveform measurement events (e.g., shots) and an error metric associated with a specified minimum count of waveform measurement events.

In some implementations, the particular solution data generated via one or more iterations is adjusted further based on one or more specified constraints. For example, particular solution data may be modified to enforce expected features of the solution data (e.g., an image) based on prior knowledge or assumptions about the observed system. As another example, particular solution data may be modified to enforce physics-based or experience-based expectations, such as an arrangement of features in the solution data.

One benefit of the method 500 is that it facilitates generation of high-quality solutions (e.g., solutions with weaker or fewer artifacts) using fewer computing resources than would be used to generate similar high-quality solutions using RTM alone. Further, the method 500 uses less waveform return data (e.g., fewer seismic imaging shots) than would be used to generate similar high-quality solutions using RTM alone. As a result, time and resources expended to gather the waveform return data can be reduced.

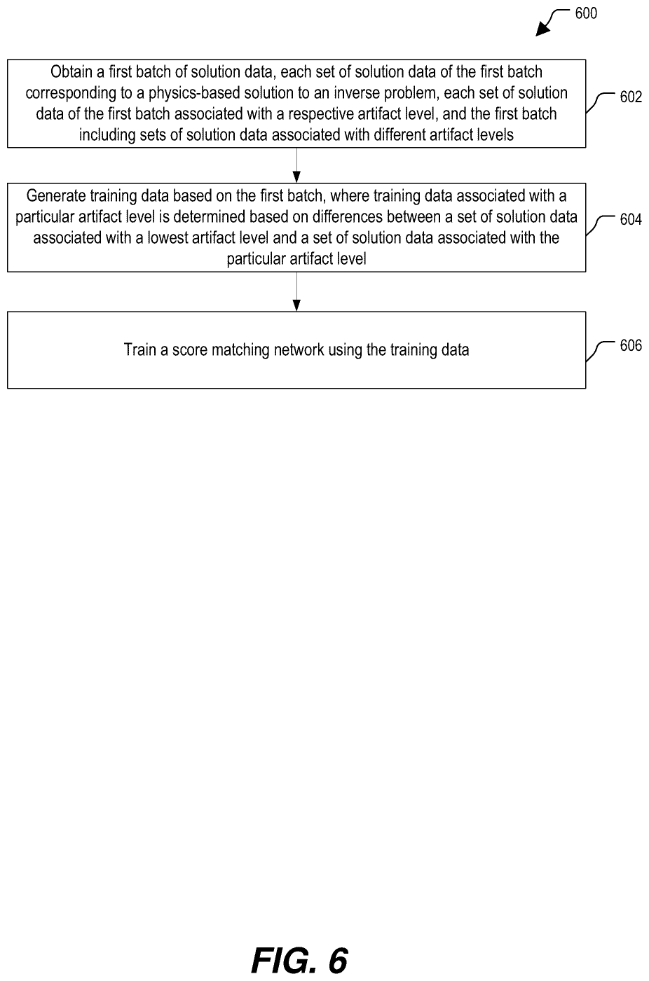

FIG. 6 is a flow chart of an example of a method of training a machine-learning model of a gradient descent artifact reduction system. One or more operations described with reference to FIG. 6 may be performed by the computer system 400 of FIG. 4, such as by the processor(s) 402 executing the instructions 444.

The method 600 includes, at 602, obtaining a first batch of solution data. Each set of solution data of the first batch corresponds to a physics-based solution to an inverse problem and is associated with a respective artifact level. For example, the sets of solution data may be determined using reverse time migration (RTM). As one specific example, RTM is performed for each set of waveform return data (e.g., each waveform return record, or each shot in a seismic imaging context) of a plurality of sets of waveform return data that are available to be processed to generate RTM data.

In this example, a first set of solution data may include RTM data based on k₁ sets of waveform return data, where k₁ is an integer that is greater than one and indicates a quantity of waveform return data included in the set. For example, the k₁ sets of waveform return data may include waveform return data associated with k₁ sampling events (e.g., k₁ shots in a seismic imaging context), and the k₁ sets of waveform return data do not include all of the waveform return data that are available for processing. Further, in this example, a second set of solution data may include RTM data based on k₂ sets of waveform return data, where k₂ is an integer that is greater than k and indicates a quantity of waveform return data included in the second set. The k₂ sets of waveform return data also do not include all of the waveform return data that are available for processing. Similarly, other sets of solution data may include RTM data for sets of waveform return data. In some implementations, a randomized process is used to select the specific sets of waveform return data (from all of the waveform return data that are available for processing) used to determine a particular set of solution data. In the same or different implementations, a randomized process is used to select a k value used to determine a quantity of waveform return data used for each set of solution data.

The method 600 includes, at 604, generating training data based on the first batch. The training data associated with a particular artifact level is determined based on differences between a set of solution data associated with a lowest artifact level and a set of solution data associated with the particular artifact level.

The method 600 includes, at 606, training a score matching network using the training data. For example, training the score matching network may include adjusting parameters of the score matching network to decrease a value of an objective function, where the value of the objective function represents a weighted sum of values of objective functions for multiple different artifact levels. In this example, a value of an objective function for a particular artifact level of the multiple different artifact levels is weighted based on a fitting parameter, and the fitting parameter is based on an error metric associated with the particular artifact level. To illustrate, a value of the error metric may be determined based on a difference between solution data associated with the particular artifact level and solution data associated with a lowest artifact level of the multiple sets of solution data.

In some implementations, the score matching network may be further trained based on one or more additional batches of training data. For example, the method 600 may include obtaining one or more second batches of solution data corresponding to physics-based solutions to the inverse problem, generating additional training data based on the one or more second batches, and training the score matching network using the additional training data.

Although FIGS. 5 and 6 describe the training and use of one particular type of machine-learning model (e.g., a score matching network), other types of machine-learning models can be used by the system 100 of FIG. 1 and the method 300 of FIG. 3. For example, a GAN can be used to generate the sets of image data 150 based on the waveform return data 120.

Particular aspects of the disclosure are highlighted in the following Examples:

Example 1 includes a system including: one or more memory devices storing instructions; and one or more processors configured to execute the instructions to: obtain waveform return data including waveform return records for multiple sampling events associated with an observed area; determine a relevance score for the waveform return records of the waveform return data, the relevance score for a particular waveform return record based, at least partially, on estimated information gain associated with the particular waveform return record; based on the relevance scores, select a first subset of waveform return records, wherein one or more waveform return records of the waveform return data are excluded from the first subset of waveform return records; and generate image data based on the first subset of waveform return records.

Example 2 includes the system of Example 1, wherein the waveform return records are indicative of reflections of one or more incident waves from visually occluded structures of the observed area.

Example 3 includes the system of Example 1 or Example 2, wherein the multiple sampling events represent multiple acquisition geometries, each acquisition geometry corresponding to one or more source locations and one or more receiver locations relative to the observed area.

Example 4 includes the system of Example 3, wherein the one or more processors are further configured to execute the instructions to select, based on the multiple acquisition geometries, a second subset of waveform return records, the second subset of waveform return records including two or more waveform return records of the waveform return data and excluding one or more waveform return records of the waveform return data, wherein the image data is generated further based on the second subset of waveform return records.

Example 5 includes the system of Example 4, wherein the second subset of waveform return records is selected based on a distribution of acquisition geometries relative to the observed area.

Example 6 includes the system of Example 4 or Example 5, wherein the first subset of waveform return records and the second subset of waveform return records are mutually exclusive.

Example 7 includes the system of any of Examples 1 to 6, wherein a number of waveform return records selected for inclusion in the first subset of waveform return records is based on a selection budget.

Example 8 includes the system of Example 7, wherein the selection budget specifies a threshold count of waveform return records to be included in the first subset of waveform return records.

Example 9 includes the system of Example 7 or Example 8, wherein the selection budget specifies a threshold relevance for determining whether a waveform return record is to be included in the first subset of waveform return records.

Example 10 includes the system of any of Examples 7 to 9, wherein the selection budget specifies a threshold count of waveform return records to be used to generate the image data, wherein the waveform return records to be used to generate the image data include the first subset of waveform return records and a second subset of waveform return records, and wherein the second subset of waveform return records are selected based on acquisition geometries.

Example 11 includes the system of any of Examples 1 to 10, wherein the relevance score is further based on an estimated information gain between multiple waveform return records.

Example 12 includes the system of any of Examples 1 to 11, wherein selection of the first subset of waveform return records includes: designating for inclusion in the first subset of waveform return records waveform return records that have high estimated information gain with respect to a structure estimate associated with the observed area and that have high estimated information gain with respect to one another; designating for omission from the first subset of waveform return records one or more waveform return records that have low estimated information gain with respect to the structure estimate; and designating for omission from the first subset of waveform return records one or more waveform return records that have low estimated information gain with respect to one another.

Example 13 includes the system of any of Examples 1 to 12, wherein the one or more processors are further configured to execute the instructions to, before determining the relevance score for the particular waveform return record, perform a data transformation to transform time-domain data of the particular waveform return record to depth-domain data, wherein the information gain is estimated based on the depth-domain data and a structure estimate associated with the observed area.

Example 14 includes the system of Example 13, wherein the data transformation includes reverse time migration based on the waveform return record.

Example 15 includes the system of Example 13, wherein the data transformation includes ray tracing based on the waveform return record.

Example 16 includes the system of any of Examples 1 to 15, wherein a value of the relevance score of the particular waveform return record is based on pixel-by-pixel comparison of a first image based on the particular waveform return record and a second image representing a structure estimate associated with the observed area.

Example 17 includes the system of any of Examples 1 to 16, wherein the one or more processors are further configured to execute the instructions to identify one or more regions of interest based on a structure estimate associated with the observed area, wherein the relevance score for each waveform return record is based on the one or more regions of interest.

Example 18 includes the system of Example 17, wherein at least one of the one or more regions of interest corresponds to a region around a boundary between two subsurface layers.

Example 19 includes the system of Example 17 or Example 18, wherein identification of the one or more regions of interest includes: segmenting the structure estimate to identify boundaries between subsurface layers; and for an identified boundary, designating a region on either side of the identified boundary as a region of interest.

Example 20 includes the system of any of Examples 17 to 19, wherein mutual information for locations within the one or more regions of interest is weighted more heavily than mutual information for locations outside the one or more regions of interest to determine the relevance score for the particular waveform return record.

Example 21 includes the system of any of Examples 1 to 20, wherein the one or more processors are further configured to execute the instructions to perform beam-domain local correction of a region of interest to generate an image based on the image data.

Example 22 includes a method including: obtaining waveform return data including waveform return records for multiple sampling events associated with an observed area; determining a relevance score for the waveform return records of the waveform return data, the relevance score for a particular waveform return record based, at least partially, on estimated information gain associated with the particular waveform return record; based on the relevance scores, selecting a first subset of waveform return records, wherein one or more waveform return records are excluded from the first subset of waveform return records; and generating image data based on the first subset of waveform return records.

Example 23 includes the method of Example 22, wherein the waveform return records are indicative of reflections of one or more incident waves from visually occluded structures of the observed area.

Example 24 includes the method of Example 22 or Example 23, wherein the multiple sampling events represent multiple acquisition geometries, each acquisition geometry corresponding to one or more source locations and one or more receiver locations relative to the observed area.

Example 25 includes the method of Example 24, further including selecting, based on the multiple acquisition geometries, a second subset of waveform return records, the second subset of waveform return records including two or more waveform return records of the waveform return data and excluding one or more waveform return records of the waveform return data, wherein the image data is generated further based on the second subset of waveform return records.

Example 26 includes the method of Example 25, wherein the second subset of waveform return records is selected based on a distribution of acquisition geometries relative to the observed area.

Example 27 includes the method of Example 25 or Example 26, wherein the first subset of waveform return records and the second subset of waveform return records are mutually exclusive.

Example 28 includes the method of any of Examples 22 to 27, wherein a number of waveform return records selected for inclusion in the first subset of waveform return records is based on a selection budget.

Example 29 includes the method of Example 28, wherein the selection budget specifies a threshold count of waveform return records to be included in the first subset of waveform return records.

Example 30 includes the method of Example 28 or Example 29, wherein the selection budget specifies a threshold relevance for determining whether a waveform return record is to be included in the first subset of waveform return records.

Example 31 includes the method of any of Examples 28 to 30, wherein the selection budget specifies a threshold count of waveform return records to be used to generate the image data, wherein the waveform return records to be used to generate the image data include the first subset of waveform return records and a second subset of waveform return records, and wherein the second subset of waveform return records are selected based on acquisition geometries.

Example 32 includes the method of any of Examples 22 to 31, wherein the relevance score is further based on an estimated information gain between multiple waveform return records.

Example 33 includes the method of any of Examples 22 to 32, wherein selecting the first subset of waveform return records includes: designating for inclusion in the first subset of waveform return records waveform return records that have high estimated information gain with respect to a structure estimate associated with the observed area and that have high estimated information gain with respect to one another; designating for omission from the first subset of waveform return records one or more waveform return records that have low estimated information gain with respect to the structure estimate; and designating for omission from the first subset of waveform return records one or more waveform return records that have low estimated information gain with respect to one another.

Example 34 includes the method of any of Examples 22 to 33, further including, before determining the relevance score for the particular waveform return record, performing a data transformation to transform time-domain data of the particular waveform return record to depth-domain data, wherein the information gain is estimated based on the depth-domain data and a structure estimate associated with the observed area.

Example 35 includes the method of Example 34, wherein the data transformation includes reverse time migration based on the waveform return record.

Example 36 includes the method of Example 34, wherein the data transformation includes ray tracing based on the waveform return record.

Example 37 includes the method of any of Examples 22 to 36, wherein a value of the relevance score of the particular waveform return record is based on pixel-by-pixel comparison of a first image based on the particular waveform return record and a second image representing a structure estimate associated with the observed area.

Example 38 includes the method of any of Examples 22 to 37, further including identifying one or more regions of interest based on a structure estimate associated with the observed area, wherein the relevance score for each waveform return record is based on the one or more regions of interest.

Example 39 includes the method of Example 38, wherein at least one of the one or more regions of interest corresponds to a region around a boundary between two subsurface layers.

Example 40 includes the method of Example 38 or Example 39, wherein identifying the one or more regions of interest includes: segmenting the structure estimate to identify boundaries between subsurface layers; and for an identified boundary, designating a region on either side of the identified boundary as a region of interest.

Example 41 includes the method of any of Examples 38 to 40, wherein mutual information for locations within the one or more regions of interest is weighted more heavily than mutual information for locations outside the one or more regions of interest to determine the relevance score for the particular waveform return record.

Example 42 includes the method of any of Examples 22 to 41, further including performing beam-domain local correction of a region of interest to generate an image based on the image data.

Example 43 includes a computer-readable storage device storing instructions that are executable by one or more processors to cause the one or more processors to: obtain waveform return data including waveform return records for multiple sampling events associated with an observed area; determine a relevance score for the waveform return records of the waveform return data, the relevance score for a particular waveform return record based, at least partially, on estimated information gain associated with the particular waveform return record; based on the relevance scores, select a first subset of waveform return records, wherein one or more waveform return records of the waveform return data are excluded from the first subset of waveform return records; and generate image data based on the first group of waveform return records.

Example 44 includes the computer-readable storage device of Example 43, wherein the waveform return records are indicative of reflections of one or more incident waves from visually occluded structures of the observed area.

Example 45 includes the computer-readable storage device of Example 43 or Example 44, wherein the multiple sampling events represent multiple acquisition geometries, each acquisition geometry corresponding to one or more source locations and one or more receiver locations relative to the observed area.

Example 46 includes the computer-readable storage device of Example 45, wherein the one or more processors are further configured to execute the instructions to select, based on the multiple acquisition geometries, a second subset of waveform return records, the second subset of waveform return records including two or more waveform return records of the waveform return data and excluding one or more waveform return records of the waveform return data, wherein the image data is generated further based on the second subset of waveform return records.

Example 47 includes the computer-readable storage device of Example 46, wherein the second subset of waveform return records is selected based on a distribution of acquisition geometries relative to the observed area.

Example 48 includes the computer-readable storage device of Example 46 or Example 47, wherein the first subset of waveform return records and the second subset of waveform return records are mutually exclusive.

Example 49 includes the computer-readable storage device of any of Examples 43 to 48, wherein a number of waveform return records selected for inclusion in the first subset of waveform return records is based on a selection budget.

Example 50 includes the computer-readable storage device of Example 49, wherein the selection budget specifies a threshold count of waveform return records to be included in the first subset of waveform return records.

Example 51 includes the computer-readable storage device of Example 49 or Example 50, wherein the selection budget specifies a threshold relevance for determining whether a waveform return record is to be included in the first subset of waveform return records.

Example 52 includes the computer-readable storage device of any of Examples 49 to 51, wherein the selection budget specifies a threshold count of waveform return records to be used to generate the image data, wherein the waveform return records to be used to generate the image data include the first subset of waveform return records and a second subset of waveform return records, and wherein the second subset of waveform return records are selected based on acquisition geometries.

Example 53 includes the computer-readable storage device of any of Examples 43 to 52, wherein the relevance score is further based on an estimated information gain between multiple waveform return records.

Example 54 includes the computer-readable storage device of any of Examples 43 to 53, wherein selecting the first subset of waveform return records includes: designating for inclusion in the first subset of waveform return records waveform return records that have high estimated information gain with respect to a structure estimate associated with the observed area and that have high estimated information gain with respect to one another; designating for omission from the first subset of waveform return records one or more waveform return records that have low estimated information gain with respect to the structure estimate; and designating for omission from the first subset of waveform return records one or more waveform return records that have low estimated information gain with respect to one another.

Example 55 includes the computer-readable storage device of any of Examples 43 to 54, wherein the one or more processors are further configured to execute the instructions to, before determining the relevance score for the particular waveform return record, perform a data transformation to transform time-domain data of the particular waveform return record to depth-domain data, wherein the information gain is estimated based on the depth-domain data and a structure estimate associated with the observed area.

Example 56 includes the computer-readable storage device of Example 55, wherein the data transformation includes reverse time migration based on the waveform return record.

Example 57 includes the computer-readable storage device of Example 55, wherein the data transformation includes ray tracing based on the waveform return record.

Example 58 includes the computer-readable storage device of any of Examples 43 to 57, wherein a value of the relevance score of the particular waveform return record is based on pixel-by-pixel comparison of a first image based on the particular waveform return record and a second image representing a structure estimate associated with the observed area.

Example 59 includes the computer-readable storage device of any of Examples 43 to 58, wherein the instructions further cause the one or more processor to identify one or more regions of interest based on a structure estimate associated with the observed area, wherein the relevance score for each waveform return record is based on the one or more regions of interest.

Example 60 includes the computer-readable storage device of Example 59, wherein at least one of the one or more regions of interest corresponds to a region around a boundary between two subsurface layers.

Example 61 includes the computer-readable storage device of Example 59 or Example 60, wherein identifying the one or more regions of interest includes: segmenting the structure estimate to identify boundaries between subsurface layers; and for an identified boundary, designating a region on either side of the identified boundary as a region of interest.

Example 62 includes the computer-readable storage device of any of Examples 59 to 61, wherein mutual information for locations within the one or more regions of interest is weighted more heavily than mutual information for locations outside the one or more regions of interest to determine the relevance score for the particular waveform return record.

Example 63 includes the computer-readable storage device of any of 43 to 62, wherein the instructions further cause the one or more processor to perform beam-domain local correction of a region of interest to generate an image based on the image data.

According to Example 64, a method includes obtaining waveform return data including waveform return records for multiple sampling events associated with an observed area; generating image data based on the first subset of waveform return records; and reducing imaging artifacts in a region of interest of the image data using beam-domain local correction operations.

According to Example 65, a device includes: a memory configured to store instructions; and one or more processors configured to execute the instructions to perform the method of Example 64.

According to Example 66, a non-transitory computer-readable medium stores instructions that, when executed by one or more processors, cause the one or more processors to perform the method of Example 64.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module or a decision model may take the form of a processing apparatus executing code, an internet based (e.g., cloud computing) embodiment, an entirely hardware embodiment, or an embodiment combining aspects of the internet, software, and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to screen shots, block diagrams and flowchart illustrations of methods, apparatuses (e.g., systems), and computer media according to various aspects. It will be understood that each functional block of a block diagram and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include one or more methods, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A method comprising:
obtaining waveform return data including waveform return records for multiple sampling events associated with an observed area;
generating image data based on a first subset of waveform return records; and
reducing imaging artifacts in a region of interest of the image data using beam-domain local correction operations.

2. The method of claim 1, wherein the beam-domain local correction operations comprise:
determining beams based on the waveform return data;
identifying a subset of the beams that pass through the region of interest; and
processing the subset of beams to reduce the imaging artifacts.

3. The method of claim 1, wherein generating the image data based on the first subset of waveform return records comprises:
determining a relevance score for the waveform return records of the waveform return data, the relevance score for a particular waveform return record based, at least partially, on estimated information gain associated with the particular waveform return record; and
based on the relevance scores, selecting a first subset of waveform return records, wherein one or more waveform return records are excluded from the first subset of waveform return records.

4. The method of claim 3, wherein the multiple sampling events represent multiple acquisition geometries, each acquisition geometry corresponding to one or more source locations and one or more receiver locations relative to the observed area.

5. The method of claim 3, wherein a number of waveform return records selected for inclusion in the first subset of waveform return records is based on a selection budget.

6. The method of claim 3, wherein selecting the first subset of waveform return records comprises:
designating for inclusion in the first subset of waveform return records waveform return records that have high estimated information gain with respect to a structure estimate associated with the observed area and that have high estimated information gain with respect to one another;
designating for omission from the first subset of waveform return records one or more waveform return records that have low estimated information gain with respect to the structure estimate; and
designating for omission from the first subset of waveform return records one or more waveform return records that have low estimated information gain with respect to one another.

7. A system comprising:
one or more memory devices storing instructions; and
one or more processors configured to execute the instructions to:
obtain waveform return data including waveform return records for multiple sampling events associated with an observed area;
generate image data based on a first subset of waveform return records; and
reduce imaging artifacts in a region of interest of the image data using beam-domain local correction operations.

8. The system of claim 7, wherein, to perform the beam-domain local correction operations, the one or more processors are configured to execute the instructions to:
determine beams based on the waveform return data;
identify a subset of the beams that pass through the region of interest; and
process the subset of beams to reduce the imaging artifacts.

9. The system of claim 7, wherein to generate the image data based on the first subset of waveform return records, the one or more processors are configured to execute the instructions to:
determine a relevance score for the waveform return records of the waveform return data, the relevance score for a particular waveform return record based, at least partially, on estimated information gain associated with the particular waveform return record; and
based on the relevance scores, select a first subset of waveform return records, wherein one or more waveform return records are excluded from the first subset of waveform return records.

10. The system of claim 9, wherein the multiple sampling events represent multiple acquisition geometries, each acquisition geometry corresponding to one or more source locations and one or more receiver locations relative to the observed area.

11. The system of claim 9, wherein a number of waveform return records selected for inclusion in the first subset of waveform return records is based on a selection budget.

12. The system of claim 9, wherein, to select the first subset of waveform return records, the one or more processors are configured to execute the instructions to:
designate for inclusion in the first subset of waveform return records waveform return records that have high estimated information gain with respect to a structure estimate associated with the observed area and that have high estimated information gain with respect to one another;
designate for omission from the first subset of waveform return records one or more waveform return records that have low estimated information gain with respect to the structure estimate; and
designate for omission from the first subset of waveform return records one or more waveform return records that have low estimated information gain with respect to one another.

13. A computer-readable storage device storing instructions that are executable by one or more processors to cause the one or more processors to:
one or more memory devices storing instructions; and
one or more processors configured to execute the instructions to:
obtain waveform return data including waveform return records for multiple sampling events associated with an observed area;
generate image data based on a first subset of waveform return records; and
reduce imaging artifacts in a region of interest of the image data using beam-domain local correction operations.

14. The computer-readable storage device of claim 13, wherein, to perform the beam-domain local correction operations, the instructions cause the one or more processors:
determine beams based on the waveform return data;
identify a subset of the beams that pass through the region of interest; and
process the subset of beams to reduce the imaging artifacts.

15. The computer-readable storage device of claim 13, wherein to generate the image data based on the first subset of waveform return records, the instructions cause the one or more processors:
determine a relevance score for the waveform return records of the waveform return data, the relevance score for a particular waveform return record based, at least partially, on estimated information gain associated with the particular waveform return record; and
based on the relevance scores, select a first subset of waveform return records, wherein one or more waveform return records are excluded from the first subset of waveform return records.

16. The computer-readable storage device of claim 15, wherein the multiple sampling events represent multiple acquisition geometries, each acquisition geometry corresponding to one or more source locations and one or more receiver locations relative to the observed area.

17. The computer-readable storage device of claim 15, wherein a number of waveform return records selected for inclusion in the first subset of waveform return records is based on a selection budget.

18. The computer-readable storage device of claim 15, wherein, to select the first subset of waveform return records, the instructions cause the one or more processors:
designate for inclusion in the first subset of waveform return records waveform return records that have high estimated information gain with respect to a structure estimate associated with the observed area and that have high estimated information gain with respect to one another;
designate for omission from the first subset of waveform return records one or more waveform return records that have low estimated information gain with respect to the structure estimate; and
designate for omission from the first subset of waveform return records one or more waveform return records that have low estimated information gain with respect to one another.
